(19) United States
(12) Patent Application Publication
(10) Pub. No.: US 2025/0350158 A1
(43) Pub. Date: Nov. 13, 2025

(54) Accelerated Search In A Multi-Coil Wireless Charging Device

(71) Applicant: AIRA, INC., Phoenix, AZ (US)

(72) Inventors: Mohammad Ali Saket Tokaldani, Phoenix, AZ (US); David Russell, Scottsdale, AZ (US); Jake Slatnick, Scottsdale, AZ (US)

(21) Appl. No.: 19/200,652

(22) Filed: May 6, 2025

Related U.S. Application Data
(60) Provisional application No. 63/643,898, filed on May 7, 2024.

(51) Int. Cl. H02J 50/90; H02J 50/12; H02J 50/40

(52) U.S. Cl. CPC H02J 50/90; H02J 50/12; H02J 50/402

(57) ABSTRACT

Systems, methods and apparatus for wireless charging are disclosed. A charging device has a plurality of charging cells provided on a charging surface, a charging circuit and a controller. The controller may be configured to initiate a search for a chargeable device using analog pings transmitted through power transmitting coils associated with the charging surface, suspend the search when a response to an analog ping transmitted through a first power transmitting coil indicates that an object is located in proximity to the wireless charging device, transmit a first digital ping through the first power transmitting coil, transmitting power through the first power transmitting coil when a response to the first digital ping is received, resume the search, and transmit power through a second power transmitting coil when a response to a second digital ping indicates that more efficient power transfer is available through the second power transmitting coil.

### PRIORITY CLAIM

This application claims priority to and the benefit of provisional patent application No. 63/643,898 filed in the United States Patent Office on May 7, 2024, the entire content of this application being incorporated herein by reference as if fully set forth below in its entirety and for all applicable purposes.

### TECHNICAL FIELD

The present invention relates generally to wireless charging of batteries, including batteries in mobile computing devices, and more particularly to a digital search procedure that enables rapid charging of a wireless charging device.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Conventional wireless charging systems typically use a “Ping” to determine if a receiving device is present on or proximate to a transmitting coil in a base station for wireless charging. The transmitter coil has an inductance (L) and a resonant capacitor that has a capacitance (C) that is coupled to the transmitting coil to obtain a resonant LC circuit. A Ping is produced by delivering power to the resonant LC circuit. Power is applied for a duration of time while the transmitter listens for a response from a receiving device. Additionally, in multi-coil wireless charging devices, the ping may be used to determine an optimal combination of coils to use for charging a battery in the receiving device.

Improvements in wireless charging capabilities are required to support continually increasing complexity of mobile devices and changing form factors. For example, there is a need for quicker initiation of charging of a receiving device by the wireless charging device.

### BRIEF DESCRIPTION OF THE DRAWINGS

FIG. 1 illustrates an example of a charging cell that may be provided on a charging surface provided by a wireless charging device in accordance with certain aspects disclosed herein.

FIG. 2 illustrates an example of an arrangement of charging cells provided on a single layer of a segment of a charging surface provided by a wireless charging device in accordance with certain aspects disclosed herein.

FIG. 3 illustrates an example of an arrangement of charging cells when multiple layers of charging cells are overlaid within a segment of a charging surface provided by a wireless charging device in accordance with certain aspects disclosed herein.

FIG. 4 illustrates the arrangement of power transfer areas provided by a charging surface of a charging device that employs multiple layers of charging cells configured in accordance with certain aspects disclosed herein.

FIG. 5 illustrates the use of differential capacitive sensing to detect location and/or orientation of a mobile communication device in accordance with certain aspects disclosed herein.

FIG. 6 is a flowchart illustrating a search process that may be conducted by a charging device in accordance with certain aspects disclosed herein.

FIG. 7 illustrates a wireless transmitter that may be provided in a charger base station in accordance with certain aspects disclosed herein.

FIG. 8 illustrates an example of a Litz transmitting coil configured in accordance with certain aspects of this disclosure.

FIG. 9 illustrates an example of a portion of a charging surface provided using multiple overlapping Litz coils in accordance with certain aspects of this disclosure.

FIG. 10 illustrates a charging assembly in a wireless charging device constructed from Litz coils according to certain aspects of this disclosure.

FIG. 11 illustrates certain aspects of a Litz coil substrate provided in accordance with certain aspects of this disclosure.

FIG. 12 illustrates a first example of a response to a passive ping in accordance with certain aspects disclosed herein.

FIG. 13 illustrates a second example of a response to a passive ping in accordance with certain aspects disclosed herein.

FIG. 14 illustrates examples of observed differences in responses to a passive ping in accordance with certain aspects disclosed herein.

FIG. 15 illustrates examples of processing circuits in a power receiving device that may be configured to encode information in an ASK-modulated signal.

FIG. 16 illustrates examples of encoding schemes that may be adapted to digitally encode messages exchanged between power receivers and power transmitters.

FIG. 17 is a flowchart that illustrates a method involving passive ping implemented in a wireless charging device adapted in accordance with certain aspects disclosed herein.

FIG. 18 is a flowchart that illustrates a power transfer management procedure that may be employed by a wireless charging device implemented in accordance with certain aspects disclosed herein.

FIG. 19 illustrates a first topology that supports matrix multiplexing switching for use in a wireless charger adapted in accordance with certain aspects disclosed herein.

FIG. 20 illustrates a second topology that supports direct current drive in a wireless charger adapted in accordance with certain aspects disclosed herein.

FIG. 21 illustrates certain aspects of a search conducted when each charging cell includes multiple coils in accordance with certain aspects disclosed herein.

FIG. 22 illustrates a charging surface with multiple charging cells, including the three illustrated charging cells involved in a search conducted in accordance with certain aspects disclosed herein.

FIG. 23 illustrates certain aspects of a search of a charging surface in accordance with this disclosure.

FIG. 24 illustrates a process for charging cell selection using pinging in wireless charging device according to aspects of the present disclosure.

FIG. 25 illustrates a flow chart of a method for coil selection using pinging in wireless charging device.

FIG. 26 illustrates another process for selection using pinging in wireless charging device according to aspects of the present disclosure

FIG. 27 illustrates a flow chart of another method for coil selection using pinging in wireless charging device.

FIG. 28 illustrates one example of an apparatus employing a processing circuit that may be adapted according to certain aspects disclosed herein.

FIG. 29 illustrates a method for searching a charging surface of a wireless charging device in accordance with certain aspects of this disclosure.

FIG. 30 illustrates a method for operating a charging device in accordance with certain aspects of this disclosure.

FIG. 31 is a flowchart illustrating an accelerated search method that may be used to search a charging surface of a wireless charging device in accordance with certain aspects of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communications (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

Certain aspects of the present disclosure relate to systems, apparatus and methods applicable to wireless charging devices and techniques. Charging cells may be configured with one or more inductive coils to provide a charging surface in a charging device where the charging surface enables the charging device to charge one or more chargeable devices wirelessly. The location of a device to be charged may be detected through sensing techniques that associate location of the device to changes in a physical characteristic centered at a known location on the charging surface. Sensing of location may be implemented using capacitive, resistive, inductive, touch, pressure, load, strain, and/or another appropriate type of sensing.

In one aspect of the disclosure, an apparatus has a battery charging power source, a plurality of charging cells configured in a matrix, a first plurality of switches in which each switch is configured to couple a row of coils in the matrix to a first terminal of the battery charging power source, and a second plurality of switches in which each switch is configured to couple a column of coils in the matrix to a second terminal of the battery charging power source. Each charging cell in the plurality of charging cells may include one or more coils surrounding a power transfer area. The plurality of charging cells may be arranged adjacent to the charging surface of the charging device without overlap of power transfer areas of the charging cells in the plurality of charging cells.

In some instances, the apparatus may also be referred to as a charging surface. Power can be wirelessly transferred to a receiving device located anywhere on a surface of the apparatus. The devices can have an arbitrarily defined size and/or shape and may be placed without regard to any discrete placement locations enabled for charging. Multiple devices can be simultaneously charged on a single charging surface. The apparatus can track motion of one or more devices across the charging surface.

According to certain aspects disclosed herein, a charging surface may be provided using charging cells in a charging device, where the charging cells are deployed adjacent to the charging surface. In one example the charging cells are deployed in one or more layers of the charging surface in accordance with a honeycomb packaging configuration. A charging cell may be implemented using one or more coils that can each induce a magnetic field along an axis that is substantially orthogonal to the charging surface adjacent to the coil. In this description, a charging cell may refer to an element having one or more coils where each coil is configured to produce an electromagnetic field that is additive with respect to the fields produced by other coils in the charging cell and directed along or proximate to a common axis. In some examples, the coils in a charging cell are formed using traces on a printed circuit board. In some examples, a coil in a charging cell is formed by spirally winding a wire to obtain a planar coil or a coil that has a generally cylindrical outline. In one example, Litz wire may be used to form a planar or substantially flat winding that provides a coil with a central power transfer area.

In some implementations, a charging cell includes coils that are stacked along a common axis and/or that overlap such that they contribute to an induced magnetic field substantially orthogonal to the charging surface. In some implementations, a charging cell includes coils that are arranged within a defined portion of the charging surface and that contribute to an induced magnetic field within the substantially orthogonal portion of the charging surface associated with the charging cell. In some implementations, charging cells may be configurable by providing an activating current to coils that are included in a dynamically-defined charging cell. For example, a charging device may include multiple stacks of coils deployed across the charging surface, and the charging device may detect the location of a device to be charged and may select some combination of stacks of coils to provide a charging cell adjacent to the device to be charged. In some instances, a charging cell may include, or be characterized as a single coil. However, it should be appreciated that a charging cell may include multiple stacked coils and/or multiple adjacent coils or stacks of coils. The coils may be referred to herein as charging coils, wireless charging coils, transmitter coils, transmitting coils, power transmitting coils, power transmitter coils, or the like.

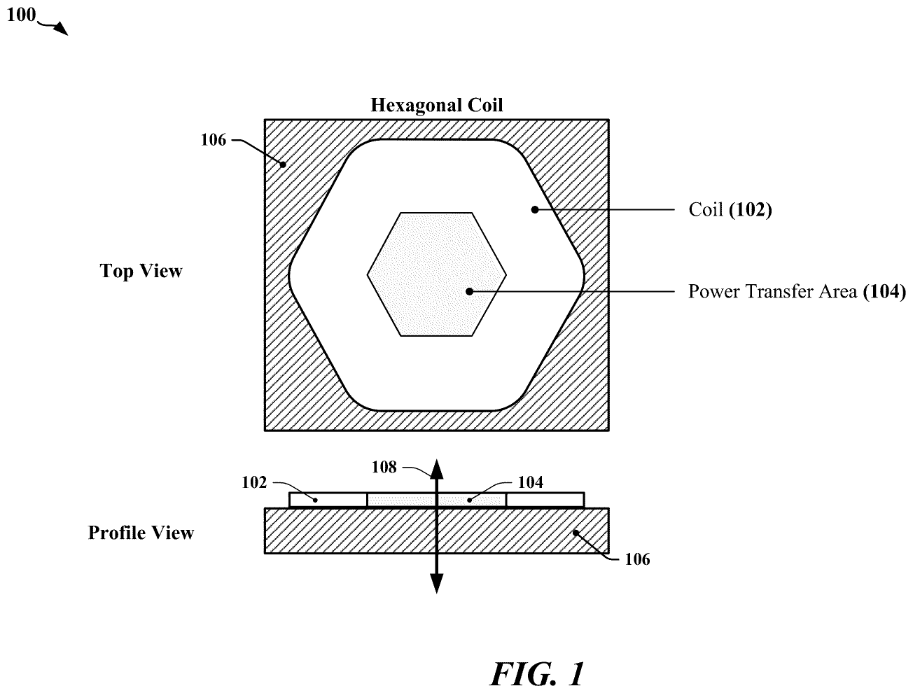

FIG. 1 illustrates an example of a charging cell 100 that may be deployed and/or configured to provide a charging surface of a charging device. As described herein, the charging surface may include an array of charging cells 100 provided on one or more substrates 106. A circuit comprising one or more integrated circuits (ICs) and/or discrete electronic components may be provided on one or more of the substrates 106. The circuit may include drivers and switches used to control currents provided to coils used to transmit power to a receiving device. The circuit may be configured as a processing circuit that includes one or more processors and/or one or more controllers that can be configured to perform certain functions disclosed herein. In some instances, some or all of the processing circuit may be provided external to the charging device. In some instances, a power supply may be coupled to the charging device.

The charging cell 100 may be provided in close proximity to an outer surface area of the charging device, upon which one or more devices can be placed for charging. The charging device may include multiple instances of the charging cell 100. In one example, the charging cell 100 has a substantially hexagonal shape that encloses one or more coils 102, which may be constructed using conductors, wires or circuit board traces that can receive a current sufficient to produce an electromagnetic field in a power transfer area 104. In various implementations, some coils 102 may have a shape that is substantially polygonal, including the hexagonal charging cell 100 illustrated in FIG. 1. Other implementations provide coils 102 that have other shapes. The shape of the coils 102 may be determined at least in part by the capabilities or limitations of fabrication technology, and/or to optimize layout of the charging cells on a substrate 106 such as a printed circuit or a substrate used to retain Litz coils in designated locations. Each coil 102 may be implemented using wires, printed circuit board traces and/or other connectors in a spiral configuration. In one example, a coil 102 may be formed by concentrically winding a Litz wire. Each charging cell 100 may span two or more layers separated by an insulator or substrate 106 such that coils 102 in different layers are centered around a common axis 108.

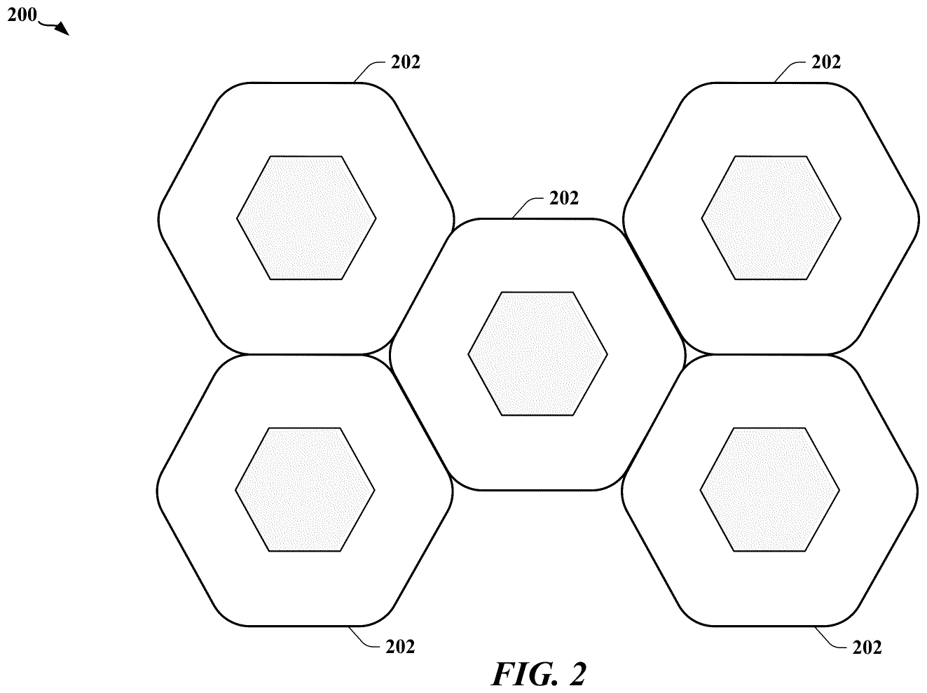

FIG. 2 illustrates an example of an arrangement 200 of charging cells 202 provided on a single layer of a segment of a charging surface of a charging device that may be adapted in accordance with certain aspects disclosed herein. The charging cells 202 are arranged according to a honeycomb packaging configuration. In this example, the charging cells 202 are arranged end-to-end without overlap. This arrangement can be provided without through-hole or wire interconnects. Other arrangements are possible, including arrangements in which some portion of the charging cells 202 overlap. For example, wires of two or more coils may be interleaved to some extent.

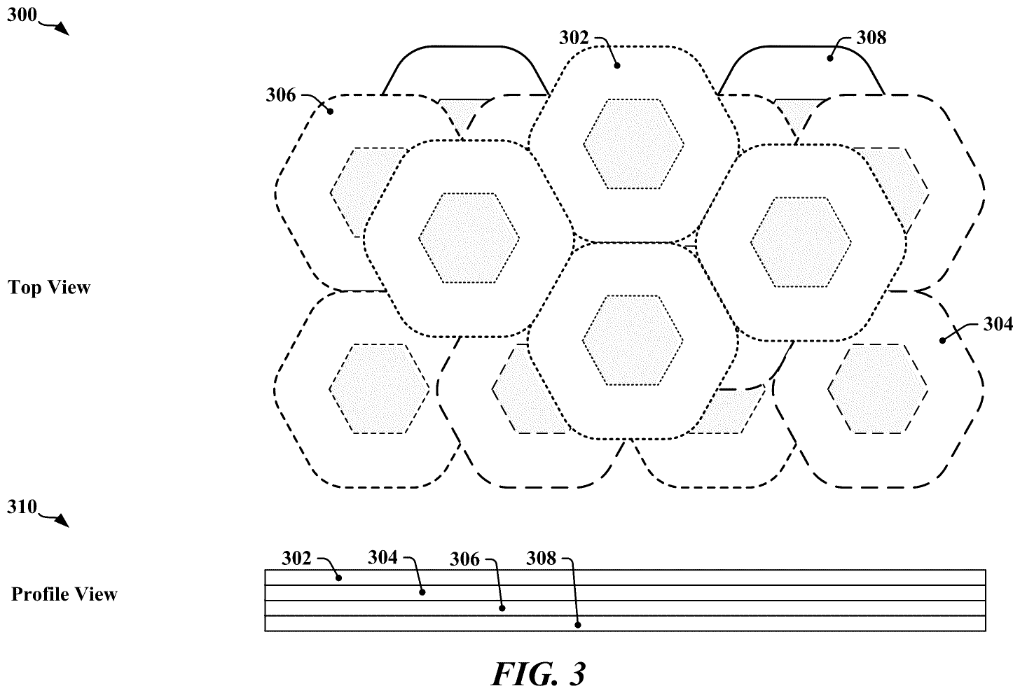

FIG. 3 illustrates an example of an arrangement of charging cells from two perspectives 300, 310 (e.g., top and profile views) when multiple layers are overlaid within a segment of a charging surface that may be adapted in accordance with certain aspects disclosed herein. Layers of charging cells 302, 304, 306, 308 are provided within a segment of a charging surface. The charging cells within each layer of charging cells 302, 304, 306, 308 are arranged according to a honeycomb packaging configuration. In one example, the layers of charging cells 302, 304, 306, 308 may be formed on a printed circuit board that has four or more layers. The arrangement of charging cells 100 can be selected to provide complete coverage of a designated charging area that is adjacent to the illustrated segment. The charging cells may be 302, 304, 306, 308 illustrated in FIG. 3 correspond to power transfer areas provided by transmitting coils that are polygonal in shape. In other implementations, the charging coils may comprise spirally wound planar coils constructed from wires, each being wound to provide a substantially circular power transfer area. In the latter examples, multiple spirally wound planar coils may be deployed in stacked planes below the charging surface of a wireless charging device.

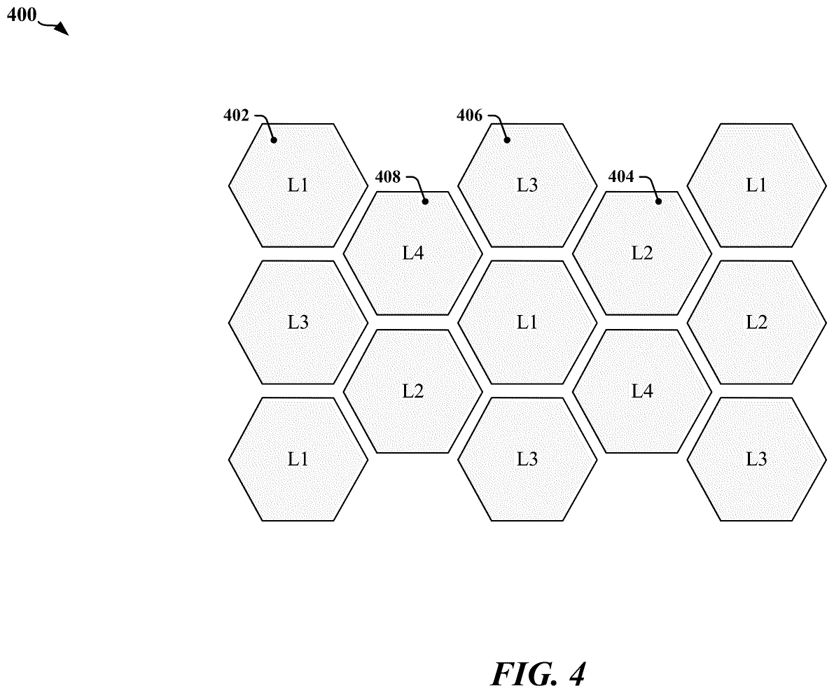

FIG. 4 illustrates the arrangement of power transfer areas provided in a charging surface 400 that employs multiple layers of charging cells configured in accordance with certain aspects disclosed herein. The illustrated charging surface is constructed from four layers of charging cells 402, 404, 406, 408, which may correspond to the layers of charging cells 302, 304, 306, 308 in FIG. 3. In FIG. 4, each power transfer area provided by a charging cell in the first layer of charging cells 402 is marked “L1”, each power transfer area provided by a charging cell in the second layer of charging cells 404 is marked “L2”, each power transfer area provided by a charging cell in the third layer of charging cells 406 is marked “L3”, and each power transfer area provided by a charging cell in the fourth layer of charging cells 408 is marked “L4”.

In accordance with certain aspects disclosed herein, location sensing may rely on changes in some property of the electrical conductors that form coils in a charging cell. Measurable differences in properties of the electrical conductors may include capacitance, resistance, inductance and/or temperature. In some examples, loading of the charging surface can affect the measurable resistance of a coil located near the point of loading. In some implementations, sensors may be provided to enable location sensing through detection of changes in touch, pressure, load and/or strain.

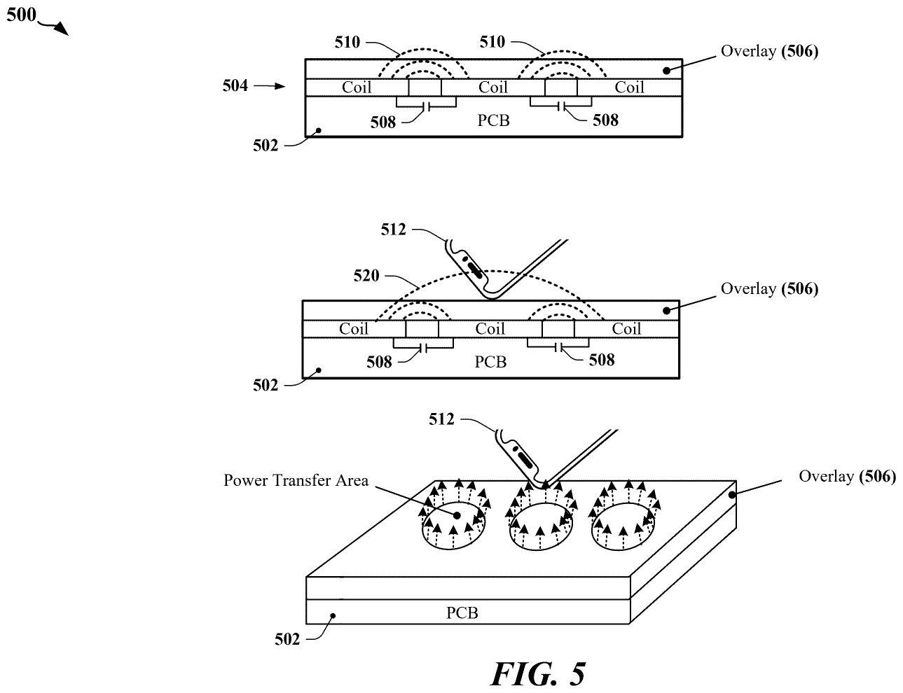

Certain aspects disclosed herein provide apparatus and methods that can sense the location of low-power devices that may be freely placed on a charging surface using differential capacitive sense techniques. FIG. 5 illustrates an example 500 of the use of differential capacitive sense to detect location and/or orientation of a mobile communication device or other object 512. One or more coils 504 are provided on a surface of a printed circuit board 502, substrate or other type of carrier. Capacitive coupling (illustrated by the dashed lines 510) can be attributed to an effective capacitance 508 measurable between pairs of the coils 504. Capacitance may be measured using a circuit coupled to each of the coils 504. An object 512, such as a chargeable device can increase or decrease the apparent capacitance 508 between the pairs of the coils 504. The object 512 may modify the capacitive coupling (illustrated by the dashed lines 520) between the pairs of the coils 504. In one example, the object 512 may affect the dielectric properties of an overlay 506, provide an alternative capacitive circuit through the object 512, or produce some other change in electrical characteristics that increases or decreases the measured or apparent value of the capacitance 508 between the pairs of the coils 504. The measured difference caused by the object 512 may be referred to as differential capacitance.

A charging device can use differential capacitive sensing to locate devices anywhere on a charging surface that includes a coil array provided according to certain aspects disclosed herein. The charging device may then determine one or more of the coils 504 that can be used to provide optimal charging of the device, which may be referred to as a receiving device.

The use of differential capacitive sensing enables an extremely low-power detection and location operation in comparison to conventional detection techniques. Conventional techniques used in current wireless charging applications for detecting devices employ “ping” methods that drive the transmitting coil and consume substantial power (e.g., 100-200 mW). The field generated by the transmitting coil is used to detect a receiving device. Differential capacitive sensing does not require powering the transmitting coil to detect presence of a receiving device and requires no additional sensing elements. The coils used in the coil array can serve as the capacitive sense elements used to find a receiving device and/or to identify physical location of the receiving device.

Differential capacitive sensing operates by measuring the differential capacitance between two adjacent coils. Differences and/or changes in capacitance can identify presence of the receiving device, without the need for a ground plane or additional conductive sense elements. Differential capacitive sensing provides a high-speed methodology that enables rapid detection of receiving devices by eliminating the need to wait for a response transmitted by a receiving device in response to a ping. Differential capacitive sensing can also sense receiving devices that have insufficient stored power to respond to a ping or query from the charging device.

According to certain aspects, presence, position and/or orientation of a receiving device may be determined using differential capacitive sensing or another location sensing technique that involves, for example, detecting differences or changes in capacitance, resistance, inductance, touch, pressure, temperature, load, strain, and/or another appropriate type of sensing. Location sensing may be employed to determine an approximate location of the device to be charged and enable a charging device to determine if a compatible device has been placed on the charging surface. For example, the charging device may determine that a compatible device has been placed on the charging surface by sending an intermittent test signal (ping) that causes a compatible device to respond. The charging device may be configured to activate one or more coils in at least one charging cell after determining receipt of a response signal defined by standard, convention, manufacturer or application. In some examples, the compatible device can respond to a ping by communicating received signal strength such that the charging device can find an optimal charging cell to be used for charging the compatible device.

In one example, a controller, state machine or other processing device may be configured to measure a capacitance attributable to one or more coils in a charging cell, and to determine whether the measured capacitance indicates proximity of a receiving device or corresponding coil in a receiving device. In some instances, the capacitance may be measured as a difference in capacitance in a sensing circuit. The controller, state machine or other processing device may maintain information that identifies expected capacitance associated with each charging cell when no receiving device is present. Differences in measured capacitance may then be used to determine that a receiving device is located near the charging cell. The size of the difference may be indicative of the distance between charging cell and the receiving device.

In some implementations, the controller, state machine or other processing device may maintain one or more profiles of the charging surface. The profiles may relate individual or groups of charging cells to expected capacitance measurements, last measured capacitances and/or historical likelihoods of capacitance values when a receiving device is present.

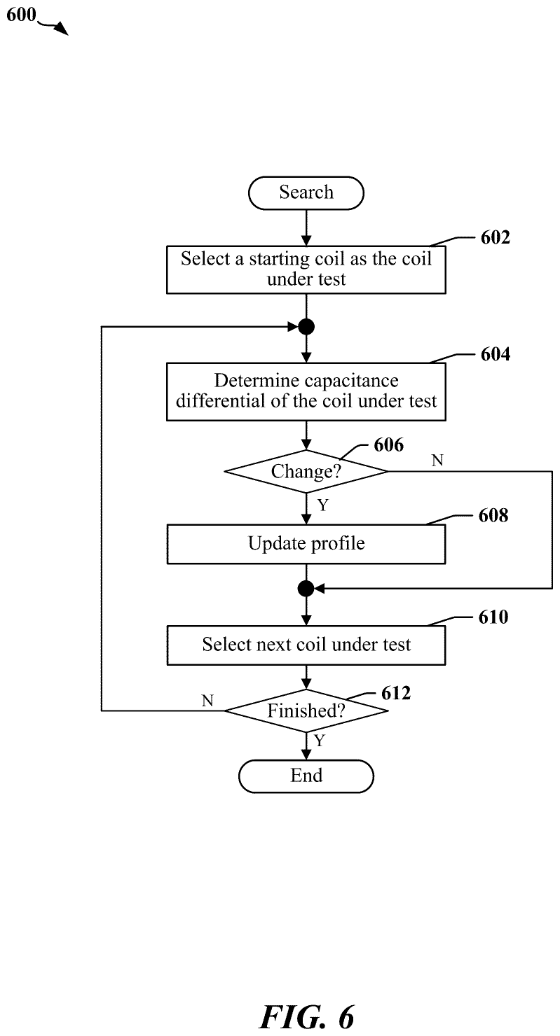

FIG. 6 is a flowchart 600 illustrating a search process that may be conducted by a charging device to determine if, or where, a device to be charged has been placed on a charging surface. The flowchart 600 may relate to individual coils provided within a charging device, to groups of coils stacked in proximity along a common axis, and/or groups of coils provided in a single charging cell 202 (see FIG. 2) or coils that service a defined area of interest of the charging surface.

At block 602, an initial coil or group of coils is selected as a starting for the search. The starting point may be selected using a pseudorandom number generator, or the like. In some instances, the starting point may be selected from a group of potential starting points that may be known or expected to be near locations that have a higher probability that a device to be charged to be present. For example, a charging device may maintain a history of searches and/or charging events that identify the location of a device that was charged and/or the charging coils or charging cells that are most frequently activated to charge devices.

At block 604, the charging device may obtain measurements of capacitance of conductors in one or more coils, or some other property associated with the coils or charging surface that may be altered in the presence of a device to be charged. The charging device may determine if the value measured property has changed from a previously measured value of the property, a nominal value, and/or values measured at a different site on the charging surface.

If a change is detected at block 604, the charging device may update a profile of the charging surface at block 608. For example, the profile may be modified to reflect the new value and/or the size of the change in the value. The profile may be used to map the potential location of a device to be charged and/or to remap or unmap devices that have been moved or removed from the charging surface. In some instances, the detection of a change or difference in the measured property may cause the charging device to initiate a ping using a charging coil that exhibited a change or triggering property value. If no change was detected at block 606, or no charging process initiated at block 608, the search may continue at block 610.

At block 610, the charging device may select a next coil to be measured. The selection may be made based on a pseudorandom sequence, using a pseudorandom number generator to select a next coil. If at block 612 it is determined that all coils to be tested have been tested, the search may be terminated. If additional coils remain to be tested, the search may continue at block 604.

When a search identifies a potential device placement on the charging surface, the charging device may begin a ping procedure to identify a charging cell, a combination of charging cells and/or a combination of coils that are to be activated to charge the device placed on the charging surface. The ping procedure verifies that the device to be charged is compatible with the charging device, and may identify a signal strength indicating whether the coils used to transmit the ping are best positioned for the requested or desired charging procedure.

Significant power savings can be achieved when a search is conducted using passive pings to locate a device before attempting to interrogate a potential chargeable device using digital pings, which may also be referred to herein as active pings. A passive ping may be characterized as a short excitation burst transmitted through a charging cell by a wireless transmitter. In one example, the short excitation burst comprises a pulse that can be less than half the period of the nominal resonant frequency of a wireless transmitter. In another example, the short excitation burst comprises a number of cycles of a signal transmitted through the charging cell at a frequency that is equal to near the nominal resonant frequency of the wireless transmitter. A conventional active ping may actively drive a transmission coil for more than 16,000 cycles of the signal transmitted through the charging cell at the nominal resonant frequency of the wireless transmitter. The power and time consumed by a conventional active ping can exceed the power and time use of a passive ping by several orders of magnitude. In one example, a passive ping consumes approximately 0.25 μJ per ping with a max ping time of around ˜100 μs, while a conventional active ping consumes approximately 80 mJ per ping with a max ping time of around 90 ms. In this example, energy dissipation may be reduced by a factor of 320,000 and the time per ping may be reduced by a factor of 900.

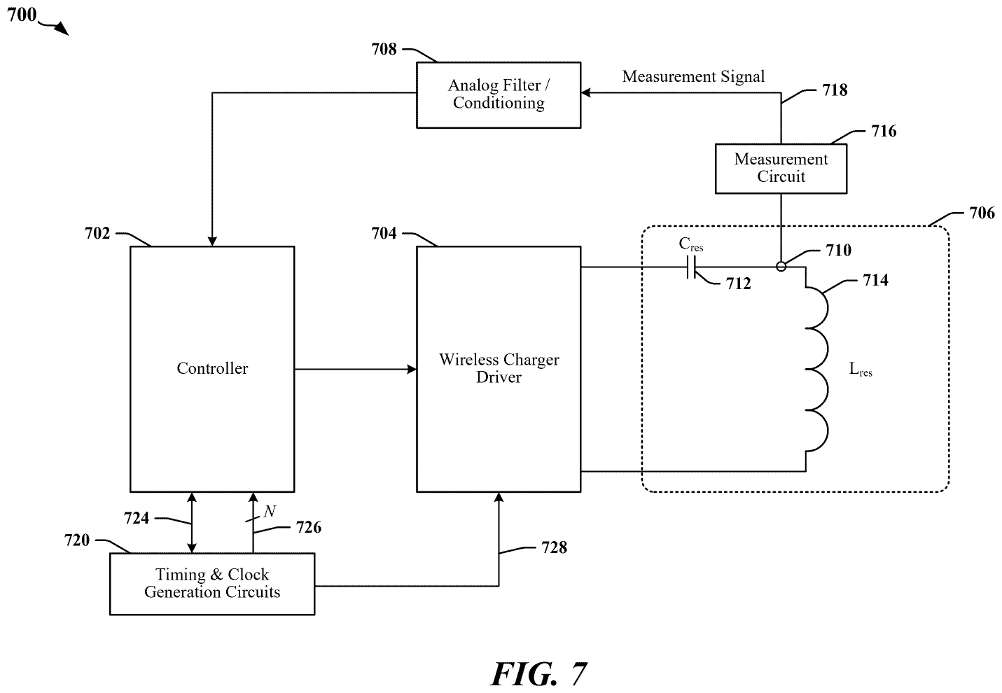

FIG. 7 illustrates a wireless transmitter 700 that may be provided in a charger base station. A controller 702 may receive a feedback signal filtered or otherwise processed by a filter circuit 708. The controller may control the operation of a driver circuit 704. The driver circuit 704 provides an alternating current to a resonant circuit 706 that includes a capacitor 712 and inductor 714. The frequency of the alternating current may be determined by a charging clock signal 728 provided by timing circuits 720. A measurement circuit 716 may generate a measurement signal 718 indicative of current flow or voltage measured at an LC node 710 of the resonant circuit 706. The measurement signal 718 may be used to calculate or estimate Q factor of the resonant circuit 706.

The timing circuits 720 may provide the controller with one or more clock signals 724, including a system clock signal that controls the operation of the controller 702. The one or more clock signals 724 may further include a clock signal used to modulate or demodulate a data signal carried on a charging current in the resonant circuit 706. The timing circuits 720 may include configurable clock generators that produce signals at frequencies defined by configuration information, including the charging clock signal 728. The timing circuits 720 may be coupled to the controller through an interface 726. The controller 702 may configure the frequency of the charging clock signal 728. In some implementations, the controller 702 may configure the duration and frequency of a pulsed signal used for passive ping in accordance with certain aspects disclosed herein. In one example, the pulsed signal includes a number of cycles of the pulsed signal.

Passive ping techniques may use the voltage and/or current measured or observed at the LC node 710 to identify the presence of a receiving coil in proximity to the charging pad of a device adapted in accordance with certain aspects disclosed herein. Many conventional wireless charger transmitters include circuits that measure voltage at the LC node 710 or measure the current in the network. These voltages and currents may be monitored for power regulation purposes and/or to support communication between devices. In the example illustrated in FIG. 7, voltage at the LC node 710 may be measured, although it is contemplated that a circuit may be adapted or provided such that current can additionally or alternatively be monitored to support passive ping. A response of the resonant circuit 706 to a passive ping (initial voltage V₀) may be represented by the voltage (V_{LC}) at the LC node 710, such that:

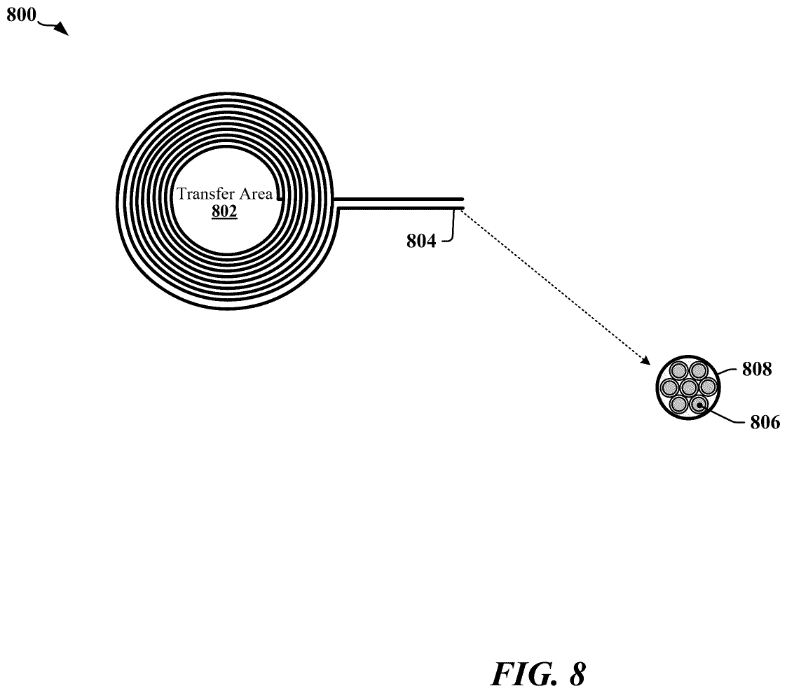

FIG. 8 illustrates an example of a transmitting coil configured in accordance with certain aspects of this disclosure. The transmitting coil may be wound from a multi-stranded Litz wire 804 and may be referred to as a Litz coil 800. Each strand 806 of the Litz wire 804 is formed as an insulated conductor that is sufficiently thin to mitigate or substantially reduce skin effect loss. Skin effect losses occur in wires carrying high frequency signals where the current tends to flow at outermost reaches (skin) of the wire. The strands 806 are insulated to maintain their individual nature and are twisted such that the relative positioning of the individual strands 806 changes over the length of the Litz wire 804. In some instances, the strands 806 are bound by an exterior insulating layer 808. The Litz coil 800 is wound as a substantially planar coil with an open interior that corresponds to the power transfer area 802.

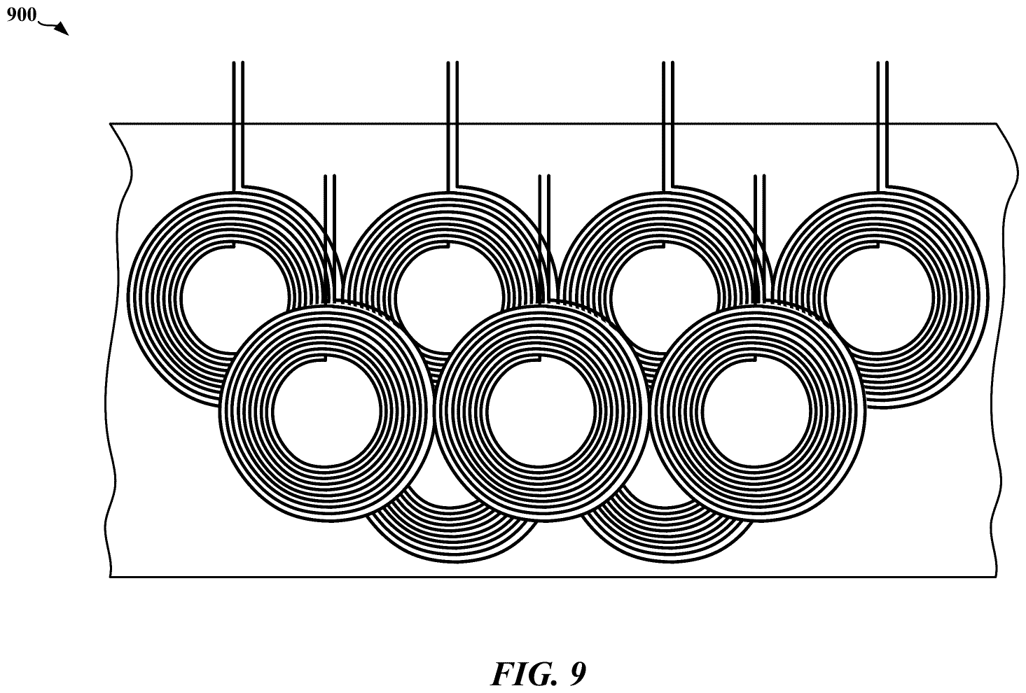

FIG. 9 illustrates an example of a portion of a charging surface 900 provided using multiple overlapping Litz coils 800. In the illustrated example, the charging surface 900 is constructed using three layers of Litz coils 800, although the number of layers of Litz coils 800 and arrangement of the Litz coils 800 in the charging surface 900 may vary according to application, size of the charging surface 900 and power transfer requirements per Litz coil 800.

The configuration of Litz coils 800 in a charging surface 900 may be precisely defined by design requirements. In some instances, it can be difficult to manage and align the number of Litz coils 800 to be assembled during manufacture of a wireless charging device that provides a free positioning charging surface using multiple transmitting coils. Variability in positioning of the Litz coils 800 during manufacture can result in imprecise configurations of coils in some finished devices. In some instances, the Litz coils 800 may be retained in position using an adhesive or epoxy resin. According to certain aspects of this disclosure, a substrate may be configured to receive the Litz coils 800 and maintain the Litz coils 800 in a desired configuration for the lifetime of the wireless charging device.

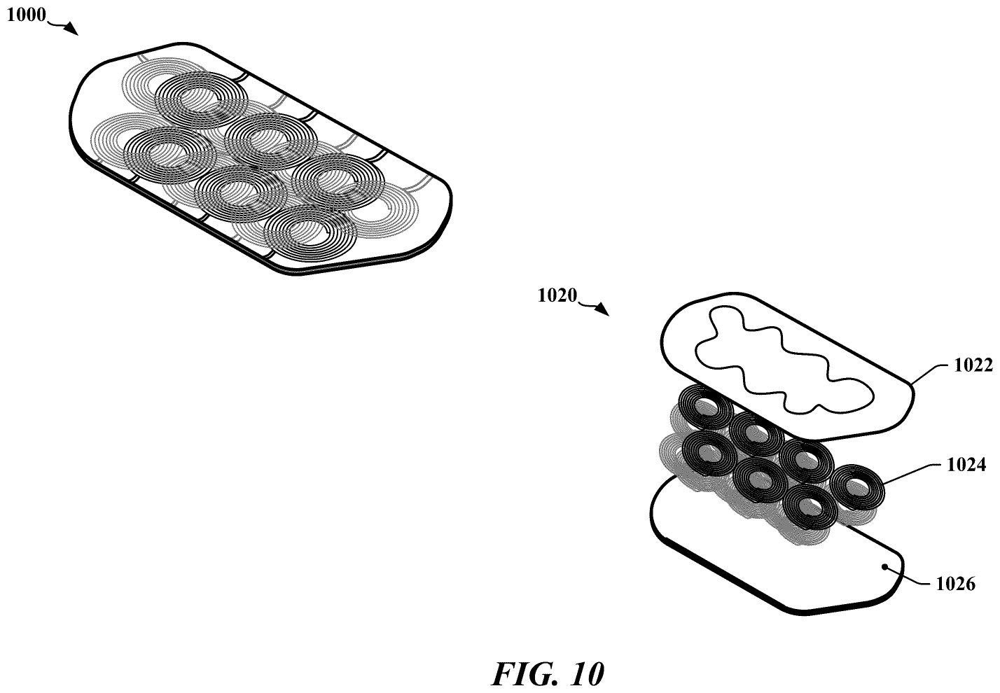

FIG. 10 illustrates a charging assembly 1000 in a wireless charging device constructed from Litz coils 800 according to certain aspects of this disclosure. The exploded view 1020 shows a Litz coil substrate 1022 configured to receive Litz coils and maintain the Litz coils in a predefined multi-layer Litz coil structure 1024 with 3D displacements between coils that meet tolerances defined by a designer. The Litz coil substrate 1022 may also define the spatial relationship between the multi-layer Litz coil structure 1024 and a ferrite layer 1026 or another type of magnetic half-core.

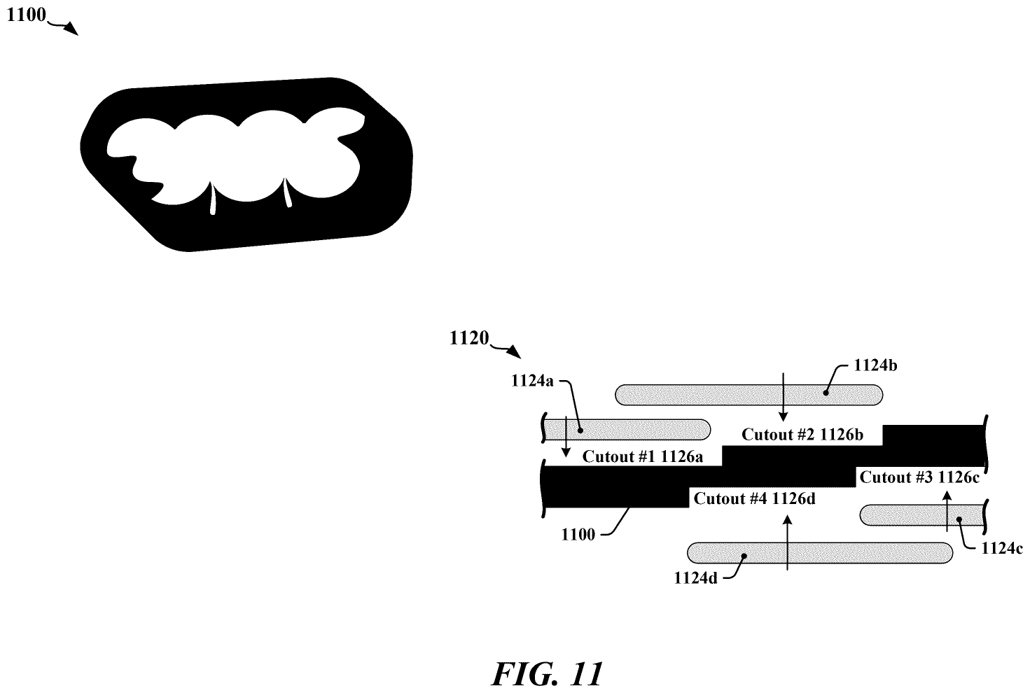

FIG. 11 illustrates certain aspects of a Litz coil substrate 1100 provided in accordance with certain aspects of this disclosure. The Litz coil substrate 1100 may be formed from a polymer, acetate, vinyl, nitrile rubber, latex, extruded polystyrene foam and/or other material. The Litz coil substrate 1100 may have multiple cutouts that enable Litz coils 800 to be placed in position in an ordered assembly. In some examples, the cut-outs may be performed, including when the Litz coil substrate 1100 is manufactured by 3D printing, molding, extrusion and/or low-pressure expansion. In some examples, the cut-outs may be formed by milling, grinding, etching, abrading, chemical erosion, chemical dissolution or by another technique suitable for use with the material used to form the Litz coil substrate 1100.

Certain aspects of the Litz coil substrate 1100 are illustrated in a cross-sectional view 1120. The illustrated Litz coil substrate 1100 provides a four-layer charging surface and the cross-sectional view 1120 illustrates an example of placement and assembly of four Litz coils 1124a-1124d. The Litz coil substrate 1100 has a deep, first cutout 1126a in the Litz coil substrate 1100 that receives a first Litz coil 1124a. This first cutout 1126a may be formed as a complete circle in some examples. In other examples, the first cutout 1126a may have a portion that overlaps a portion of another cutout in the same plane of the Litz coil substrate 1100.

When the first Litz coil 1124a has been secured within the first cutout 1126a, a second Litz coil 1124b may be placed in a second cutout 1126b in the Litz coil substrate 1100. When in position within the Litz coil substrate 1100, the second Litz coil 1124b lies in a plane above the plane that includes the first Litz coil 1124a. A portion of the second Litz coil 1124b overlaps a portion of the first Litz coil 1124a. The separation of the planes that include the horizontal center lines of the first Litz coil 1124a and the second Litz coil 1124b may be configured by the relative difference in depths of the first cutout 1126a and the second cutout 1126b.

The third Litz coil 1124c is received by a deep, third cutout 1126c in the Litz coil substrate 1100. This third cutout 1126c may be formed as a complete circle in some examples. In other examples, the third cutout 1126c may overlap with another cutout in the same plane. In one example, the third cutout 1126c may partially overlap the first cutout 1126a resulting in a through-hole, when the bottom surface of the first Litz coil 1124a is in the same plane as the top surface or some other portion of the third Litz coil 1124c.

When the third Litz coil 1124c has been secured within the third cutout 1126c, a fourth Litz coil 1124d may be placed in a fourth cutout 1126d. The fourth Litz coil 1124d lies in a plane below the plane that includes the third Litz coil 1124c. A portion of the fourth Litz coil 1124d overlaps a portion of the third Litz coil 1124c when secured within the Litz coil substrate 1100. The separation of the planes that include the horizontal center lines of the third Litz coil 1124c and the fourth Litz coil 1124d may be configured by the relative difference in depths of the third cutout 1126c and the fourth cutout 1126d.

A Litz coil 1124a-1124d may be secured within the Litz coil substrate 1100 through a pressure fit, including when the Litz coil substrate 1100 is manufactured from a foam material. In some examples, a Litz coil 1124a-1124d may be secured within the Litz coil substrate 1100 by adhesive. In some examples, a Litz coil 1124a-1124d may be secured within the Litz coil substrate 1100 by mechanical means.

In some implementations, a completed charging assembly comprising the Litz coil substrate 1100 and the Litz coils 1124a-1124d may be attached to, or mounted on a substrate, which may be retained within a housing that can be mounted under a countertop, for example. In some implementations, the completed charging assembly comprising the Litz coil substrate 1100 and the Litz coils 1124a-1124d may be attached to, or mounted on a printed circuit board, which may be retained within a housing.

According to certain aspects of this disclosure, a search may be conducted using passive pings to identify objects that may be chargeable devices placed on or near in a multi-coil, free position charging pad. Active pings may then be used to establish whether the object is a chargeable device that is configured to receive charge from the wireless charging device. A valid or compatible chargeable device is expected to respond to the active ping by modulating the flux transmitted by the wireless charging device to encode information that can be detected and decoded at the transmitter. Savings in power consumption can be obtained by refraining from providing active pings until a potential device is detected in a search, thereby limiting the number of active ping transmissions needed to detect presence of a chargeable device and establish an electromagnetic charging connection with the detected chargeable device.

Wireless charging devices may be adapted in accordance with certain aspects disclosed herein to support a low-power discovery technique that can replace and/or supplement conventional active ping transmissions. A conventional active ping is produced by driving a resonant LC circuit that includes a transmitting coil of a base station. The base station then waits for an amplitude-shift keying (ASK)-modulated response from the receiving device. A low-power discovery technique may include utilizing a passive ping to provide fast and/or low-power discovery. According to certain aspects, an analog, or passive ping, may be produced by driving a network that includes the resonant LC circuit with a fast pulse that includes a small amount of energy. The fast pulse excites the resonant LC circuit and causes the network to oscillate at its natural resonant frequency until the injected energy decays and is dissipated. In one example, the fast pulse may have a duration corresponding to a half cycle of the resonant frequency of the network and/or the resonant LC circuit. When the base station is configured for wireless transmission of power within the frequency range 100 kHz to 200 kHz, the fast pulse may have a duration that is less than 2.5 μs.

The passive ping may be characterized and/or configured based on the natural frequency at which the network including the resonant LC circuit rings, and the rate of decay of energy in the network. The ringing frequency of the network and/or resonant LC circuit may be defined as:

$$ω = \frac{1}{\sqrt{LC}} \qquad ( Eq . 1 )$$

The rate of decay is controlled by the quality factor (Q factor) of the oscillator network, as defined by:

$$Q = \frac{1}{R} \sqrt{\frac{L}{C}} \qquad ( Eq . 2 )$$

Equations 1 and 2 show that resonant frequency is affected by L and C, while the Q factor is affected by L, C and R. In a base station provided in accordance with certain aspects disclosed herein, the wireless driver has a fixed value of C determined by the selection of the resonant capacitor. The values of L and R are determined by the wireless transmitting coil and by an object or device placed adjacent to the wireless transmitting coil.

The wireless transmitting coil is configured to be magnetically coupled with a receiving coil in a device placed within close proximity of the transmitting coil, and to couple some of its energy into the proximate device to be charged. The L and R values of the transmitter circuit can be affected by the characteristics of the device to be charged, and/or other objects within close proximity of the transmitting coil. As an example, if a piece of ferrous material with a high magnetic permeability placed near the transmitter coils can increase the total inductance (L) of the transmitter coil, resulting in a lower resonant frequency, as shown by Equation 1. Some energy may be lost through heating of materials due to eddy current induction, and these losses may be characterized as an increase the value of R thereby lowering the Q factor, as shown by Equation 2.

A wireless receiver placed in close proximity to the transmitter coil can also affect the Q factor and resonant frequency. The receiver may include a tuned LC network with a high Q which can result in the transmitter coil having a lower Q factor. The resonant frequency of the transmitter coil may be reduced due to the addition of the magnetic material in the receiver, which is now part of the total magnetic system. Table 1 illustrates certain effects attributable to different types of objects placed within close proximity to the transmitter coil.

TABLE 1

| Object | L | R | Q | Frequency |
|---|---|---|---|---|
| None present | Base Value | Base value | Base Value (High) | Base Value |
| Ferrous | Small Increase | Large Increase | Large Decrease | Small Decrease |
| Non-ferrous | Small Decrease | Large Increase | Large Decrease | Small Increase |
| Wireless Receiver | Large Increase | Small Decrease | Small Decrease | Large Decrease |

In the example illustrated in FIG. 7, voltage at the LC node 710 is monitored, although it is contemplated that current may additionally or alternatively be monitored to support passive ping. A response of the resonant circuit 706 to a passive ping (initial voltage V₀) may be represented by the voltage (V_{LC}) at the LC node 710, such that:

$${V}_{LC} = {V}_{0} {e}^{- ( \frac{ω}{2 Q} ) t} \qquad ( Eq . 3 )$$

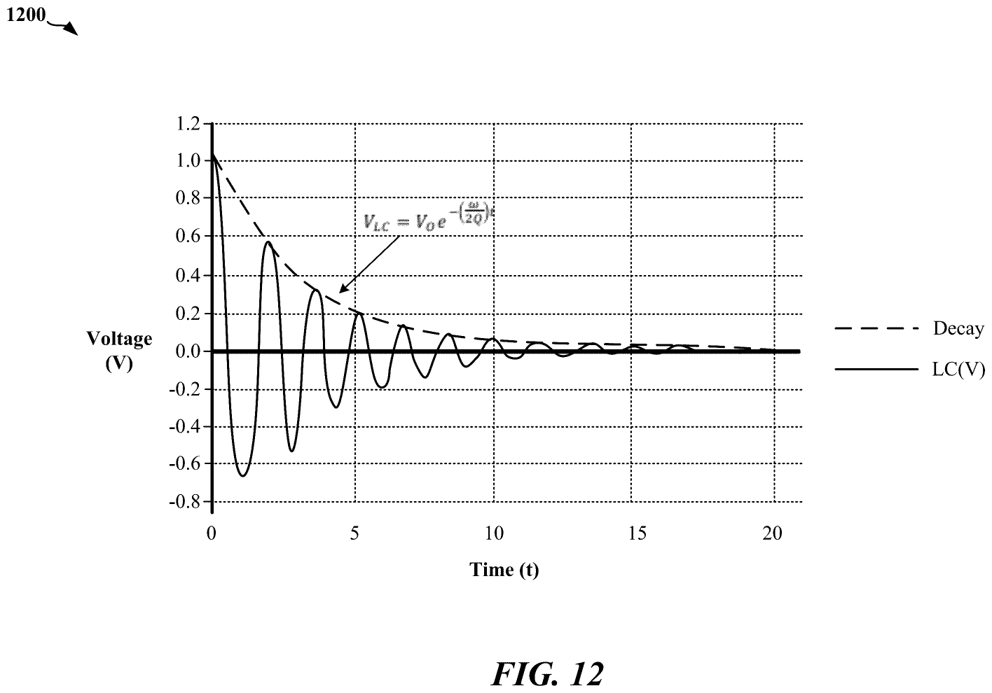

FIG. 12 illustrates a first example in which a response 1200 to a passive ping decays according to Equation 3. After the excitation pulse at time=0, the voltage and/or current is seen to oscillate at the resonant frequency defined by Equation 1, and with a decay rate defined by Equation 3. The first cycle of oscillation begins at voltage level V₀ and V_{LC} continues to decay to zero as controlled by the Q factor and ω. The example illustrated in FIG. 12 represents a typical open or unloaded response when no object is present or proximate to the charging pad. In FIG. 12 the value of the Q factor is assumed to be 20.

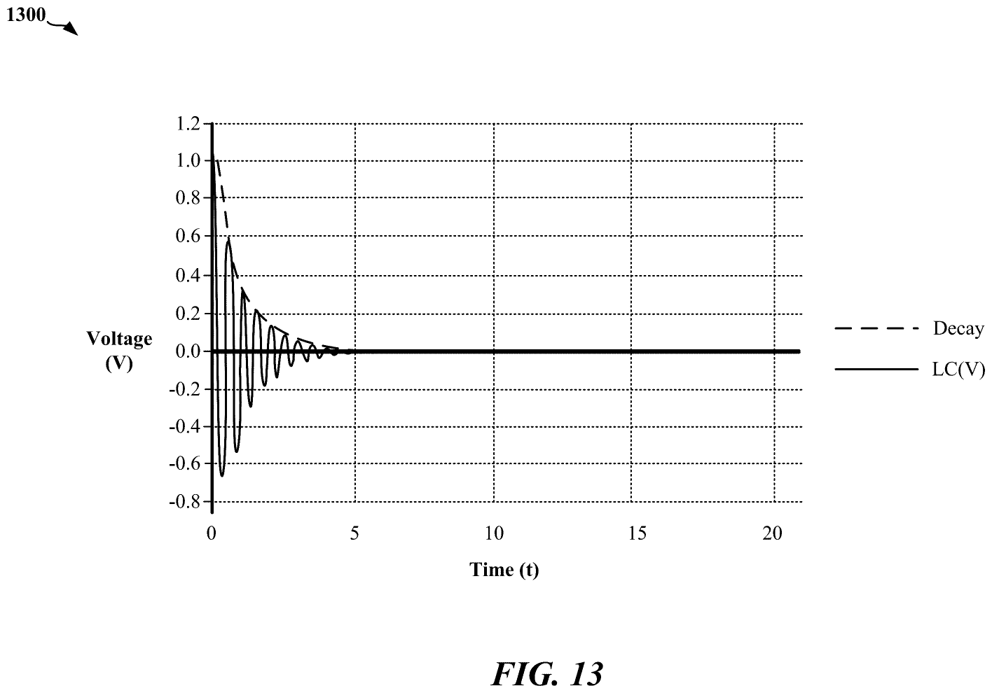

FIG. 13 illustrates a second example in which a response 1300 to a passive ping decays according to Equation 3. After the excitation pulse at time=0, the voltage and/or current is seen to oscillate at the resonant frequency defined by Equation 1, and with a decay rate defined by Equation 3. The first cycle of oscillation begins at voltage level V₀ and V_{LC} continues to decay to zero as controlled by the Q factor and ω. The example illustrated in FIG. 13 represents a loaded response when an object is present or proximate to the charging pad loads the coil. In FIG. 12 the Q factor may have a value of 7. V_{LC} oscillates at a higher frequency in the voltage response 1300 with respect to the voltage response 1200.

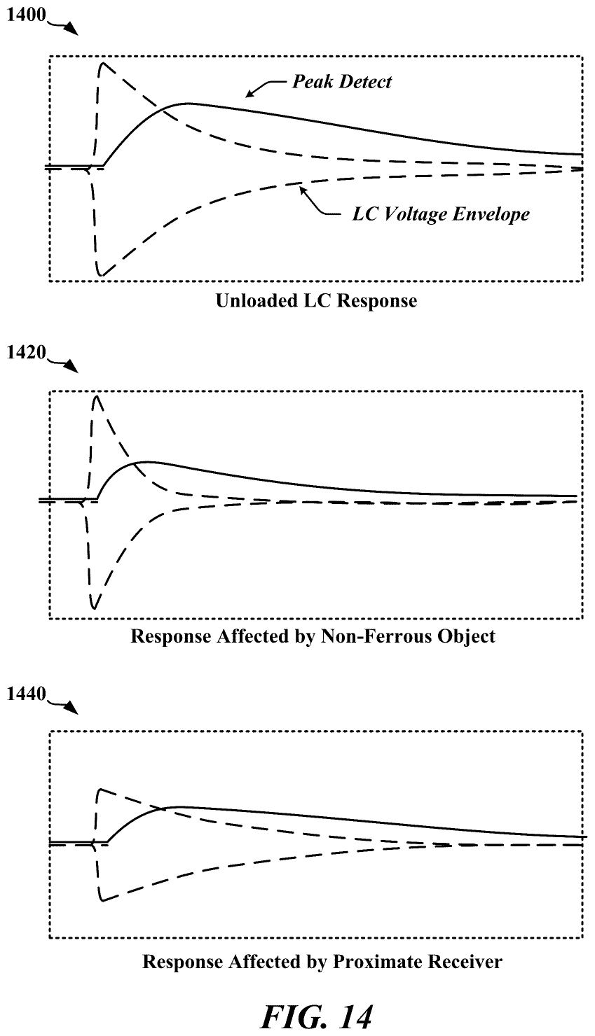

FIG. 14 illustrates a set of examples in which differences in responses 1400, 1420, 1440 may be observed. A passive ping is initiated when a driver circuit 704 excites the resonant circuit 706 using a pulse that is shorter than 2.5 μs. Different types of wireless receivers and foreign objects placed on the transmitter result in different responses observable in the voltage at the LC node 710 or current in the resonant circuit 706 of the transmitter. The differences may indicate variations in the Q factor of the resonant circuit 706 frequency of the oscillation of V₀. Table 2 illustrates certain examples of objects placed on the charging pad in relation to an open state.

TABLE 2

| Object | Frequency | Vₚₑₐₖ (mV) | 50% Decay Cycles | Q Factor |
|---|---|---|---|---|
| None present | 96.98 kHz | 134 mV | 4.5 | 20.385 |
| Type-1 Receiver | 64.39 kHz | 82 mV | 3.5 | 15.855 |
| Type-2 Receiver | 78.14 kHz | 78 mV | 3.5 | 15.855 |
| Type-3 Receiver | 76.38 kHz | 122 mV | 3.2 | 14.496 |
| Misaligned Type-3 Receiver | 210.40 kHz | 110 mV | 2.0 | 9.060 |
| Ferrous object | 93.80 kHz | 110 mV | 2.0 | 9.060 |
| Non-ferrous object | 100.30 kHz | 102 mV | 1.5 | 6.795 |

In Table 2, the Q factor may be calculated as follows:

$$Q = \frac{π N}{ln ( 2 )} ≅ 4.53 N , \qquad ( Eq . 3 )$$

where N is the number of cycles from excitation until amplitude falls below 0.5 V₀.

Certain aspects of the disclosure relate to the use of active, or digital, pings to exchange and establish information related to device configuration, control, status and other attributes and parameters that may determine certain aspects of power transmission between a power transmitter in a wireless charging device and a power receiver in a chargeable device. The configuration, control, status and other information may be communicated wirelessly before and during power transmission in messages encoded in accordance with standards-defined protocols. In one example, Qi protocols enable the power receiver to transmit requests to the power transmitter that permit the power receiver to exercise some control over the power transmitter. Qi protocols are implemented in many wireless charging devices to manage the wireless interconnection between a power transmitter to a power receiver. Qi protocols provide for the exchange of messages from power receiver to power transmitter by way of Amplitude Shift Keying (ASK) modulation that produces an ASK signal carried in the electromagnetic flux between the power transmitter and power receiver.

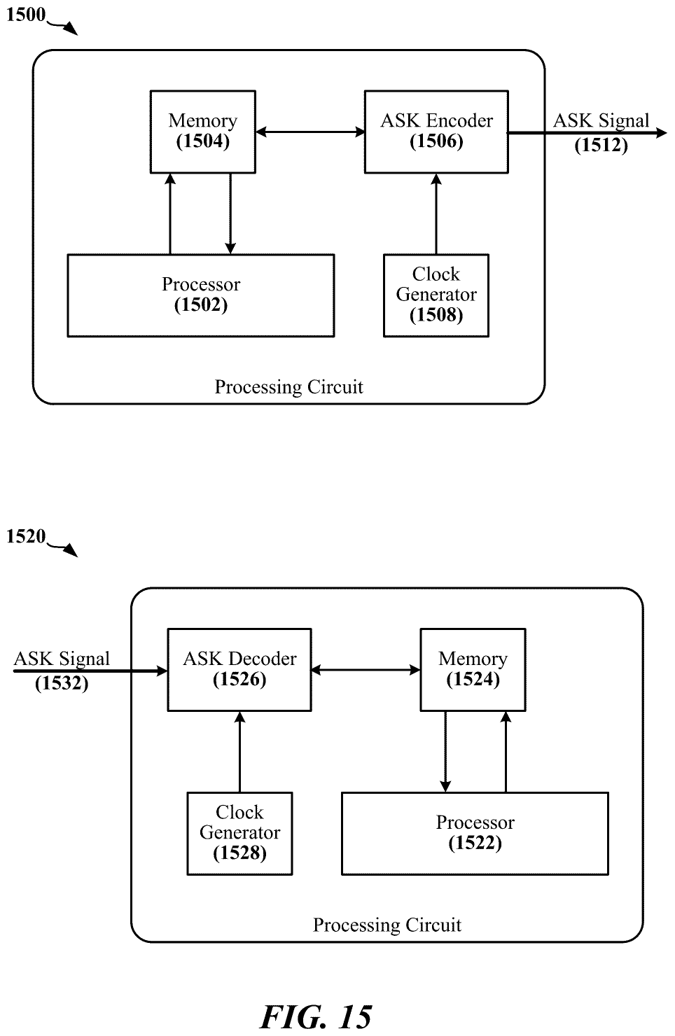

FIG. 15 illustrates an example of a processing circuit 1500 in a power receiving device that may be configured to encode information in an ASK-modulated signal 1512. The processing circuit 1500 includes a processor 1502 which may be coupled to a memory device 1504, registers or other types of storage operable to store messages to be transmitted in the ASK-modulated signal 1512. The processing circuit 1500 includes an ASK encoder 1506 that may be implemented using hardware, software or some combination of hardware and software. The ASK encoder 1506 may use a clock signal received from a clock generation or recovery circuit 1508 to control timing of transmission of the ASK-modulated signal 1512.

The processor 1502 may comprise a microprocessor, a digital signal processor (DSP), a finite state machine, a microcontroller, or another type of controller. The processor 1502 may configure and/or cause the ASK encoder 1506 to modulate voltage or current in the tank circuit of a wireless power transmitting device. In one example, the voltage or current in the tank circuit of the wireless power transmitting device may be modulated by causing step changes in the inductance of a resonant circuit in the power receiving device. The changes in the inductance modify the inductance of the tank circuit of the wireless power transmitting device through the electromagnetic coupling between transmitting and receiving devices.

FIG. 15 illustrates an example of a processing circuit 1520 that may be configured to receive and decode an ASK-modulated signal 1532. The processing circuit 1520 includes a processor 1522 which may be coupled to a memory device 1524, registers or other types of storage operable to store messages decoded from the ASK-modulated signal 1532. The processing circuit 1520 includes an ASK decoder 1526 that may be implemented using hardware, software or some combination of hardware and software. The ASK decoder 1526 may use a clock signal received from a clock generation or recovery circuit 1528 to control sampling and decoding of the ASK-modulated signal 1532.

The processor 1522 may comprise a microprocessor, a DSP, a finite state machine, a microcontroller, or another type of controller. The processor 1522 may configure or control the operation of the ASK decoder 1526. In some implementations, the ASK decoder 1526 may operate as a demodulator that provided a demodulated signal to be processed by some combination of deserializing or decoding logic and the processor 1522. With reference also to FIG. 7, the ASK-modulated signal 1532 may represent or be derived from changes in the amplitude of charging current or voltage measured at an LC node 710 of the resonant circuit 706. In many examples, interrupts can be used to determine or measure timing between level changes on the ASK-modulated signal 1532. In one example, a demodulation circuit may cooperate with a timer provided by a microcontroller (MCU) to generate interrupts used to calculate time between edges. A sequence of time measurements may be used to decode the ASK-modulated signal 1532. In another example, a DSP or digital signal controller may be used to demodulate the ASK-modulated signal using digital signal processing methods.

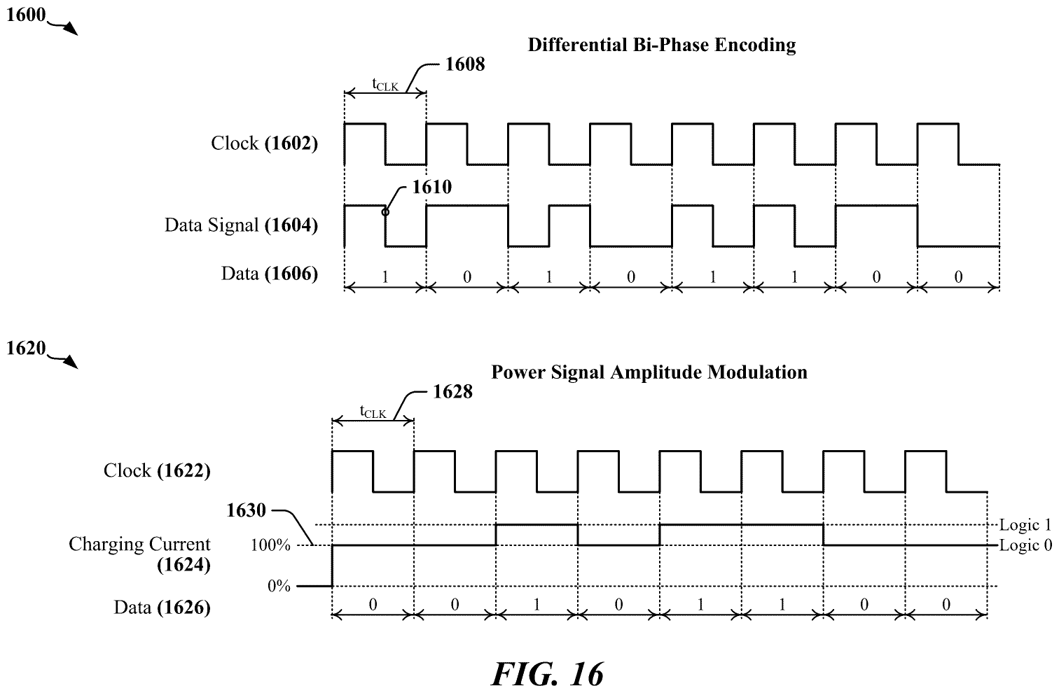

FIG. 16 illustrates examples of encoding schemes 1600, 1620 that may be adapted to digitally encode messages exchanged between power receivers and power transmitters. In the first example, a differential bi-phase encoding scheme 1600 encodes binary bits in the phase of a data signal 1604. In the illustrated example, each bit of a data byte 1606 is encoded in a corresponding cycle 1608 of an encoder clock signal 1602. The value of each bit is encoded in the presence or absence of a transition 1610 (phase change) in the data signal 1604 during the corresponding cycle 1608.

In the second example, a tank voltage or charging current 1624 is encoded using a power signal amplitude encoding scheme 1620. In the illustrated example, binary bits of a data byte 1626 are encoded in level of the charging current 1624. Each bit of the data byte 1626 is encoded in a corresponding cycle 1628 of an encoder clock signal 1622. The value of each bit is encoded in the voltage level of the charging current 1624 relative to a nominal 100% voltage level 1630 of the charging current 1624 during the corresponding cycle 1608.

ASK modulation by the receiver can be appreciated by referring again to FIG. 7. The charging current provided to the resonant circuit 706 by the driver circuit 704 in the wireless transmitter 700 of FIG. 7 causes the inductor 714 to produce an electromagnetic flux that is coupled to the receiving coil in a receiving circuit provided in the chargeable device. The chargeable device can communicate information to the base station in the wireless charging device by modulating the charging current through the LC node 710 and/or the voltage at the LC node 710. The receiving device can modulate the charging current or the voltage measured at the LC node 710 by changing the electromagnetic coupling between a transmitting coil and the receiving coil in the receiving device in accordance with a pulse-width modulated signal, for example. The inductance provided by the transmitting and receiving coils contribute to the inductance represented by the inductor 714 in the resonant circuit 706. The coupling between the transmitting and receiving coils may be changed by modifying the impedance presented by the receiving circuit in the chargeable device to the wireless transmitter 700.

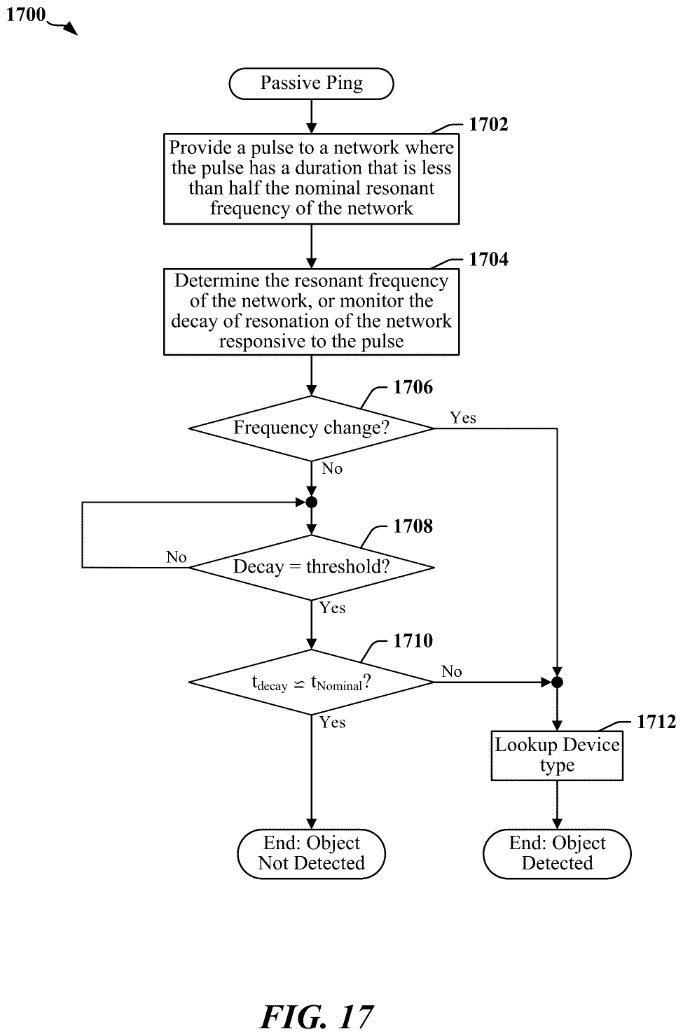

FIG. 17 is a flowchart 1700 that illustrates a method of searching involving passive ping implemented in a wireless charging device adapted in accordance with certain aspects disclosed herein. At block 1702, a controller may generate a short excitation pulse and may provide the short excitation pulse to a network that includes a resonant circuit. The network may have a nominal resonant frequency and the short excitation pulse may have a duration that is less than half the nominal resonant frequency of the network. The nominal resonant frequency may be observed when the transmitting coil of the resonant circuit is isolated from external objects, including ferrous objects, non-ferrous objects and/or receiving coils in a device to be charged. In some examples, the short excitation pulse has a duration corresponding to one or more cycles of the nominal resonant frequency of the network. In some examples, the short excitation pulse has a duration corresponding to at least five cycles of the nominal resonant frequency of the network.

At block 1704, the controller may determine the resonant frequency of the network or may monitor the decay of resonation of the network responsive to the pulse. According to certain aspects disclosed herein, the resonant frequency and/or the Q factor associated with the network may be altered when a device or other object is placed in proximity to the transmitting coil. The resonant frequency may be increased or decreased from the nominal resonant frequency observed when the transmitting coil of the resonant circuit is isolated from external objects. The Q factor of the network may be increased or decreased with respect to a nominal Q factor measurable when the transmitting coil of the resonant circuit is isolated from external objects. According to certain aspects disclosed herein, the duration of delay can be indicative of the presence or type of an object placed in proximity to the transmitting coil when differences in Q factor prolong or accelerate decay of amplitude of oscillation in the resonant circuit with respect to delays associated with a nominal Q factor.

In one example, the controller may determine the resonant frequency of the network using a transition detector circuit configured to detect zero crossings of a signal representative of the voltage at the LC node 710 using a comparator or the like. In some instances, direct current (DC) components may be filtered from the signal to provide a zero crossing. In some instances, the comparator may account for a DC component using an offset to detect crossings of a common voltage level. A counter may be employed to count the detected zero crossings. In another example the controller may determine the resonant frequency of the network using a transition detector circuit configured to detect crossings through a threshold voltage by a signal representative of the voltage at the LC node 710, where the amplitude of the signal is clamped or limited within a range of voltages that can be detected and monitored by logic circuits. In this example, a counter may be employed to count transitions in the signal. The resonant frequency of the network may be measured, estimated and/or calculated using other methodologies.

In another example, a timer or counter may be employed to determine the time elapsed for V_{LC} to decay from voltage level V₀ to a threshold voltage level. The elapsed time may be used to represent a decay characteristic of the network. The threshold voltage level may be selected to provide sufficient granularity to enable a counter or timer to distinguish between various responses 1400, 1420, 1440 to the pulse. V_{LC} may be represented by detected or measured peak, peak-to-peak, envelope and/or rectified voltage level. The decay characteristic of the network may be measured, estimated and/or calculated using other methodologies.

If at block 1706, the controller determines that a change in resonant frequency with respect to a nominal resonant frequency indicate presence of an object in proximity to the transmitting coil, the controller may attempt to identify the object at block 1712. If the controller determines at block 1706 that resonant frequency is substantially the same as the nominal resonant frequency, the controller may consider the decay characteristic of the amplitude of oscillation in the resonant circuit at block 1708. The controller may determine that the resonant frequency of the network is substantially the same as the nominal resonant frequency when the frequency remains within a defined frequency range centered on, or including the nominal resonant frequency. In some implementations, the controller may identify objects using changes in resonant frequency and decay characteristics. In these latter implementations, the controller may continue at block 1708 regardless of resonant frequency, and may use a change in resonant frequency as an additional parameter when identifying an object positioned proximately the transmission coil.

At block 1708, the controller may use a timer and/or may count the cycles of the oscillation in the resonant circuit that have elapsed between the initial V₀ amplitude and a threshold amplitude used to assess the decay characteristic. In one example, V₀/2 may be selected as the threshold amplitude. At block 1710, the number of cycles or the elapsed time between the initial V₀ amplitude and the threshold amplitude may be used to characterize decay in the amplitude of oscillation in the resonant circuit, and to compare the characterize decay with a corresponding nominal decay characteristic. If at block 1710, no change in frequency and delay characteristic is detected, the controller may terminate the procedure with a determination that no object is proximately located to the transmission coil. If at block 1710, a change in frequency and/or delay characteristic has been detected, the controller may identify the object at block 1712.

At block 1712, the controller may be configured to identify receiving devices placed on a charging pad. The controller may be configured to ignore other types of objects, or receiving devices that are not optimally placed on the charging pad including, for example, receiving devices that are misaligned with the transmission coil that provides the passive ping. In some implementations, the controller may use a lookup table indexed by resonant frequency, decay time, change in resonant frequency, change in decay time and/or Q factor estimates. The lookup table may provide information identifying specific device types, and/or charging parameters to be used when charging the identified device or type of device.

In some examples, passive ping uses a very short excitation pulse that can be less than a half-cycle of the nominal resonant frequency observed at the LC node 710 in the resonant circuit 706. A conventional ping may actively drive a transmission coil for more than 16,000 cycles. The power and time consumed by a conventional ping can exceed the power and time use of a passive ping by several orders of magnitude. In one example, a passive ping consumes approximately 0.25 μJ per ping with a max ping time of around ˜100 μs, while a conventional active ping consumes approximately 80 mJ per ping with a max ping time of around 90 ms. In this example, energy dissipation may be reduced by a factor of 320,000 and the time per ping may be reduced by a factor of 900.

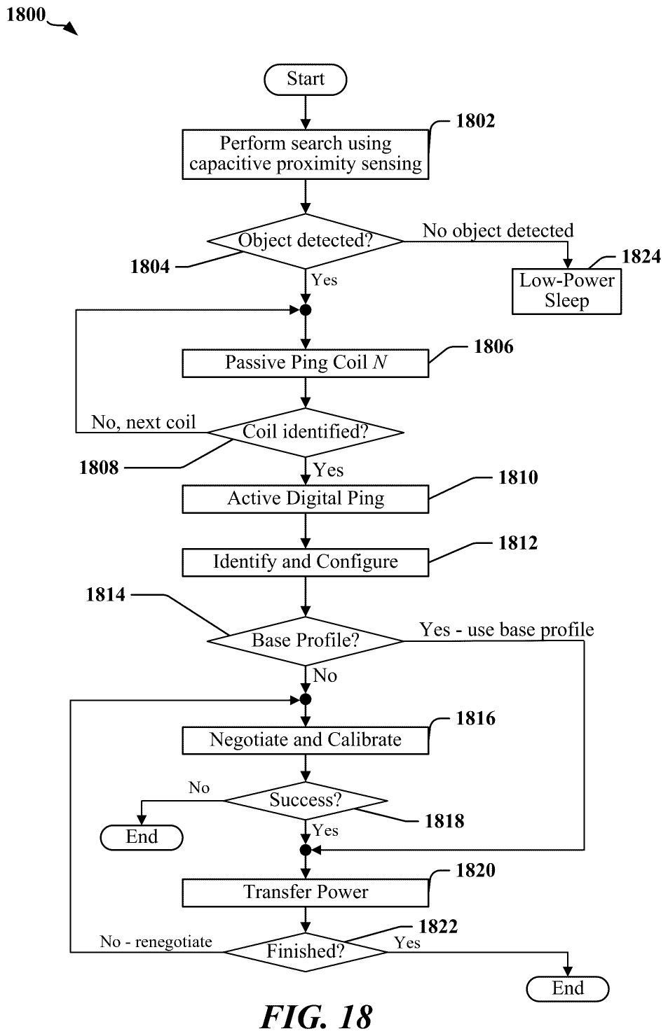

Passive ping may also be coupled with another, reduced-power sensing methodology, such as capacitive sensing. Capacitive sensing or the like can provide an ultra-low power detection method that determines presence or non-presence of an object is in proximity to the charging surface. After capacitive sense detection, a passive ping can be transmitted sequentially or concurrently on each coil to produce a more accurate map of where a potential receiving device and/or object is located. After a passive ping procedure has been conducted, an active ping (e.g., active digital ping) may be provided in the most likely device locations. An example algorithm for device location sensing, identification and charging is illustrated in FIG. 18.

FIG. 18 is a flowchart 1800 that illustrates a power transfer management procedure involving multiple sensing and/or interrogation techniques that may be employed by a wireless charging device implemented in accordance with certain aspects disclosed herein. The procedure may be initiated periodically and, in some instances, may be initiated after the wireless charging device exits a low-power or sleep state. In one example, the procedure may be repeated at a frequency calculated to provide sub-second response to placement of a device on a charging pad. The procedure may be re-entered when an error condition has been detected during a first execution of the procedure, and/or after charging of a device placed on the charging pad has been completed.

At block 1802, a controller may perform an initial search using capacitive proximity sensing. Capacitive proximity sensing may be performed quickly and with low power dissipation. In one example, capacitive proximity sensing may be performed iteratively, where one or more transmission coils is tested in each iteration. The number of transmission coils tested in each iteration may be determined by the number of sensing circuits available to the controller. At block 1804, the controller may determine whether capacitive proximity sensing has detected the presence or potential presence of an object proximate to one of the transmission coils. If no object is detected by capacitive proximity sensing, the controller may cause the charging device to enter a low-power, idle and/or sleep state at block 1824. If an object has been detected, the controller may initiate passive ping sensing at block 1806.

At block 1806, the controller may initiate passive ping sensing to confirm presence of an object near one or more transmission coils, and/or to evaluate the nature of the proximately located object. Passive ping sensing may consume a similar quantity of power but span a greater of time than capacitive proximity sensing. In one example, each passive ping can be completed in approximately 100 μs and may expend 0.25 μJ. A passive ping may be provided to each transmission coil identified as being of interest by capacitive proximity sensing. In some implementations, a passive ping may be provided to transmission coils near each transmission coil identified as being of interest by capacitive proximity sensing, including overlaid transmission coils. At block 1808, the controller may determine whether passive ping sensing has detected the presence of a potentially chargeable device proximate to one of the transmission coils that may be a receiving device. If a potentially chargeable device has been detected, the controller may initiate active digital ping sensing at block 1810. If no potential chargeable device has been detected, passive ping sensing may continue at block 1806 until all of the coils have been tested and/or the controller terminates passive ping sensing. In one example, the controller terminates passive ping sensing after all transmitting coils have been tested. When passive ping sensing fails to find a potentially chargeable device, the controller may cause the charging device to enter a low-power, idle and/or sleep state. In some implementations, passive ping sensing may be paused when a potentially chargeable device is detected so that an active ping can be used to interrogate the potentially chargeable device. Passive ping sensing may be resumed after the results of an active ping have been obtained.

At block 1810, the controller may use an active ping to interrogate a potentially chargeable device. The active ping may be provided to a transmitting coil identified by passive ping sensing. In one example, a standards-defined active ping exchange can be completed in approximately 90 ms and may expend 80 mJ. An active ping may be provided to each transmission coil associated with a potentially chargeable device. At block 1812, the controller may identify and configure a chargeable device. The active ping provided at block 1810 may be configured to stimulate a chargeable device such that it transmits a response that includes information identifying the chargeable device. In some instances, the controller may fail to identify or configure a potentially chargeable device detected by passive ping, and the controller may resume a search based on passive ping at block 1806. At block 1814, the controller may determine whether a baseline charging profile or negotiated charging profile should be used to charge an identified chargeable device. The baseline, or default charging profile may be defined by standards. In one example, the baseline profile limits charging power to 5 W. In another example, a negotiated charging profile may enable charging to proceed at up to 15 W. When a baseline charging profile is selected, the controller may begin transferring power (charging) at block 1820.

At block 1816, the controller may initiate a standards-defined negotiation and calibration process that can optimize power transfer. The controller may negotiate with the chargeable device to determine an extended power profile that is different from a power profile defined for the baseline charging profile. The controller may determine at block 1818 that the negotiation and calibration process has failed and may terminate the power transfer management procedure. When the controller determines at block 1818 that the negotiation and calibration process has succeeded, charging in accordance with the negotiate profile may commence at block 1820.

At block 1822, the controller may determine whether charging has been successfully completed. In some instances, an error may be detected when a negotiated profile is used to control power transfer. In the latter instance, the controller may attempt to renegotiate and/or reconfigure the profile at block 1816. The controller may terminate the power transfer management procedure when charging has been successfully completed.

According to certain aspects disclosed herein, coils in one or more charging cells may be selectively activated to provide an optimal electromagnetic field for charging a compatible device. In some instances, coils may be assigned to charging cells, and some charging cells may overlap other charging cells. In the latter instances, the optimal charging configuration may be selected at the charging cell level. In other instances, charging cells may be defined based on placement of a device to be charged on a charging surface. In these other instances, the combination of coils activated for each charging event can vary. In some implementations, a charging device may include a driver circuit that can select one or more cells and/or one or more predefined charging cells for activation during a charging event.

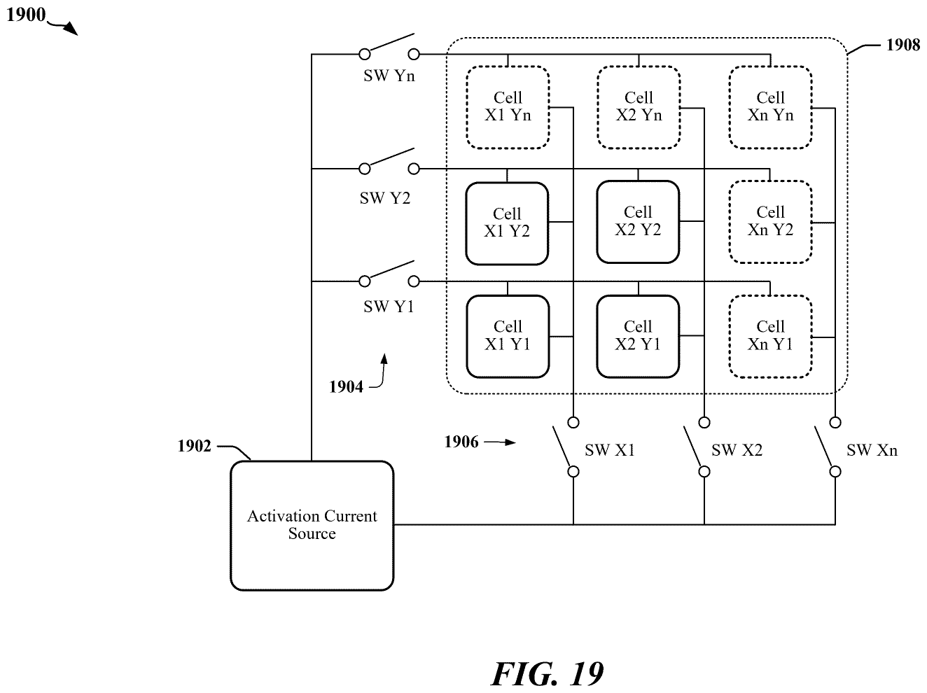

FIG. 19 illustrates a first topology 1900 that supports matrix multiplexing switching for use in a wireless charger adapted in accordance with certain aspects disclosed herein. The wireless charger may select one or more charging cells 100 to charge a receiving device. Charging cells 100 that are not in use can be disconnected from current flow. A relatively large number of charging cells 100 may be used in the honeycomb packaging configuration illustrated in FIG. 2 requiring a corresponding number of switches. According to certain aspects disclosed herein, the charging cells 100 may be logically arranged in a matrix 1908 having multiple cells connected to two or more switches that enable specific cells to be powered. In the illustrated topology 1900, a two-dimensional matrix 1908 is provided, where the dimensions may be represented by X and Y coordinates. Each of a first set of switches 1906 is configured to selectively couple a first terminal of each cell in a column of cells to a wireless transmitter and/or receiver circuit 1902 that provide current to activate coils during wireless charging. Each of a second set of switches 1904 is configured to selectively couple a second terminal of each cell in a row of cells to the wireless transmitter and/or receiver circuit 1902. A cell is active when both terminals of the cell are coupled to the wireless transmitter and/or receiver circuit 1902.

The use of a matrix 1908 can significantly reduce the number of switching components needed to operate a network of tuned LC circuits. For example, N individually connected cells require at least N switches, whereas a two-dimensional matrix 1908 having N cells can be operated with VN switches. The use of a matrix 1908 can produce significant cost savings and reduce circuit and/or layout complexity. In one example, a 9-cell implementation can be implemented in a 3×3 matrix 1908 using 6 switches, saving 3 switches. In another example, a 16-cell implementation can be implemented in a 4×4 matrix 1908 using 8 switches, saving 8 switches.

During operation at least 2 switches are closed to actively couple one coil to a wireless transmitter and/or receiver circuit 1902. Multiple switches can be closed at once in order to facilitate connection of multiple coils to the wireless transmitter and/or receiver circuit 1902. Multiple switches may be closed, for example, to enable modes of operation that drive multiple transmitting coils when transferring power to a receiving device.

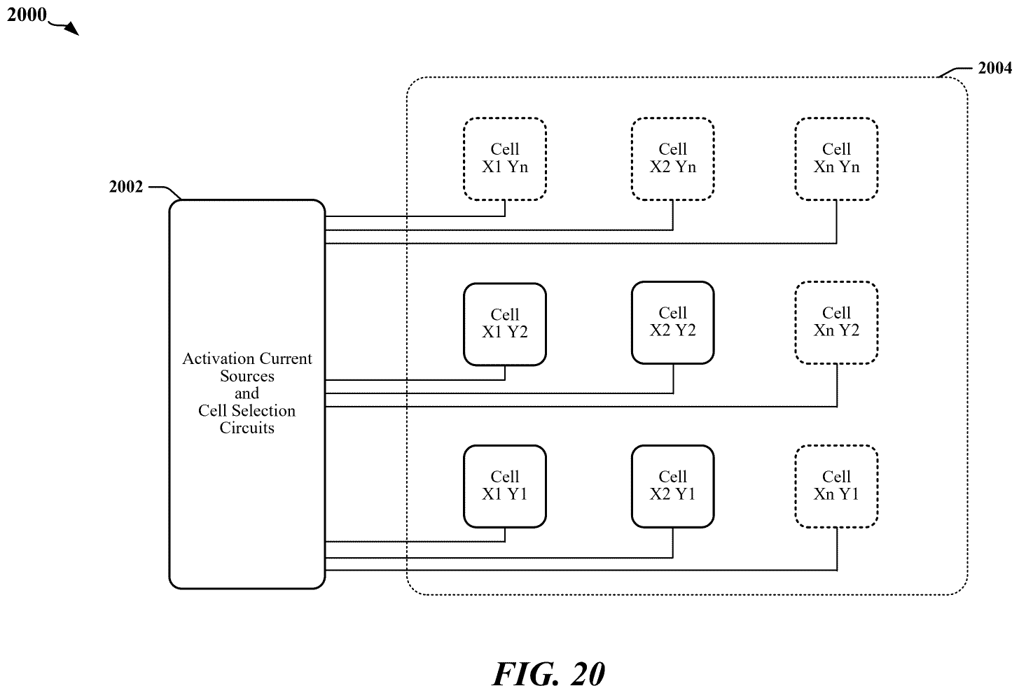

FIG. 20 illustrates a second topology 2000 in which each coil or charging cell is individually and/or directly driven by a driver circuit 2002 in accordance with certain aspects disclosed herein. The driver circuit 2002 may be configured to select one or more coils or charging cells 100 from a group of coils 2004 to charge a receiving device. It will be appreciated that the concepts disclosed here in relation to charging cells 100 may be applied to selective activation of individual coils or stacks of coils. Charging cells 100 that are not in use receive no current flow. A relatively large number of charging cells 100 may be in use and a switching matrix may be employed to drive individual coils or groups of coils. In one example, a first switching matrix may configure connections that define a charging cell or group of coils to be used during a charging event and a second switching matrix (see, e.g., FIG. 19) may be used to activate the charging cell and/or group of selected coils.

The availability of direct drive to one or more coils may permit the charging device to concurrently transmit a ping through different charging cells 202 (see FIG. 2) or other groupings or configurations of coils.

In some implementations, capacitive sense can be used to determine location by first connecting two adjacent coils to the capacitive sense circuitry. Using these two coils the circuitry measures the capacitance by using one or more known methods. A first method includes applying a constant current waveform and calculating capacitance based on changes in voltage sensed by a measuring circuit. Calculation can be based on the following equations:

$$Q = C * V$$

$$Q = I * t$$

If a known charge is delivered (Q) by sourcing a known constant current (I) for a specified amount of time (t), the voltage (V) can be measured from which the capacitance (C) can be calculated. Measured capacitance can be compared to the last recorded measured value. Certain changes in capacitance are significant enough to indicate that the system has changed, enabling detection that something has become part of the system (e.g., a phone).

Changes in capacitance can be measured through the use of an RC time constant. A constantly varying square wave signal can be applied across a known resistance (R) and the unknown capacitance (C or Cx). The time to charge/discharge can them be measured using a timer and comparator. By using the time constant equation, capacitance can be calculated.

Capacitance measurements may be taken from coils in a defined sequence until all locations have been tested. Changes and/or magnitude of changes measured from the coils can identify location of a device to be charged. The process can be repeated in a cycle that may repeat based on a configured interval time. The scan rate may be selected based on a compromise between speed of detection and power draw. If lower power draw levels are desired scan rate can be decreased at the expense of lower detection speed or vice versa.

After sensing a device location, the location of one or more devices can be determined. Locations may be indicated by the combination of coils that register a large enough change in capacitance. Coils can be turned on in a first-come, first-serve basis. As devices are added, associated coils proximate to the device can be connected to a driver and activated. The number of devices that can be charged may be limited by the number drivers available to service devices.

Current flow through each of the coils is defined roughly by an appropriate wireless charging standard (e.g., the Qi standard), frequency, amplitude, etc. Certain aspects disclosed herein relate to identifying coils in an array activated using an array of switches and corresponding circuitry and/or algorithms.

According to certain aspects of this disclosure, the area that can be utilized for charging increases with the total surface area of the disclosed charging device. In conventional wireless chargers, a single Qi coil transmitter has an effective power transfer area that is <9.2% (based on the A6 coil, the most commonly used coil). A layout of coils provided in accordance with certain aspects disclosed herein can accomplish much higher ratios for charge area vs total area. In one example, a 100 mm×200 mm, 3-device configuration has an available charging area that is 57.2% of the charging device surface area. In another example, a 200 mm×200 mm, 6-device configuration has an available charging area that is 63.5% of the charging device surface area.

According to certain aspects, presence, position and/or orientation of a receiving device may be determined by searching the charging cells for differences in capacitance using a search pattern. The search pattern may be pseudo-random to improve average time to detect a charging device. In some implementations, the starting point of the search may be selected based on a history of measurements captured when a receiving device was in proximity and receiving charge. In some implementations, an initial group of charging cells may be prioritized for searching based on a history of measurements captured when a receiving device was in proximity and receiving charge.

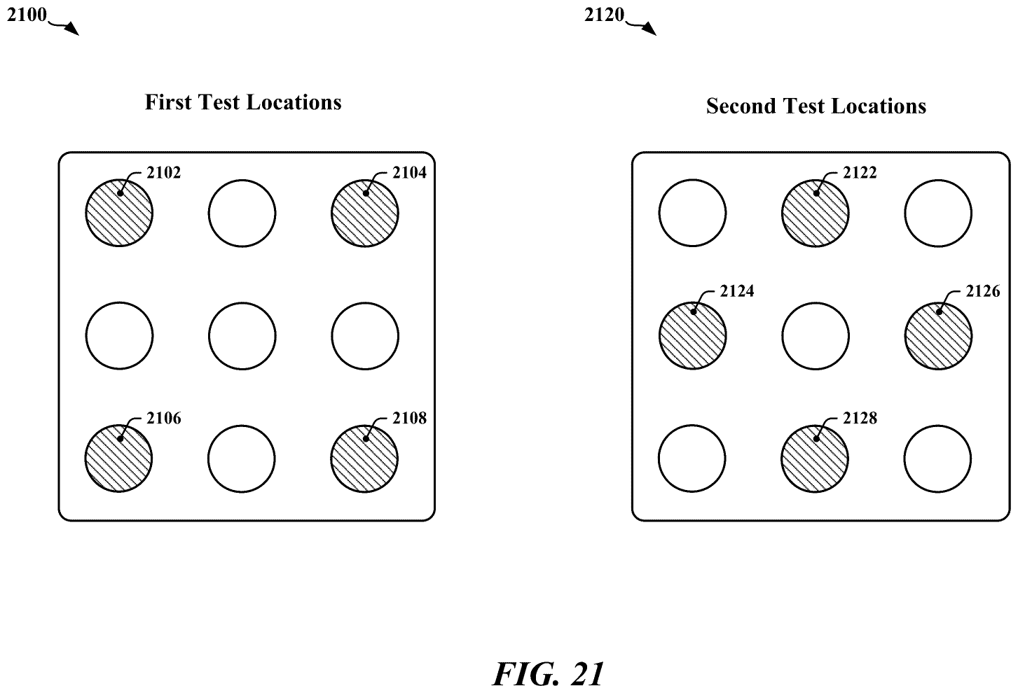

FIG. 21 illustrates certain aspects of a search conducted in a grouping of coils that includes multiple coils 2102, 2104, 2106, 2108, 2122, 2124, 2126, 2128. In some implementations, a search may be conducted by measuring differences in measurable properties of different groupings of coils 2100, 2120. In the illustrated example, a combined property of a first grouping of coils 2100 that includes coils 2102, 2104, 2106, 2108 may be assessed independently of the combined property of a second grouping of coils 2120 that includes coils 2122, 2124, 2126, 2128. The groupings of coils 2100, 2120 may be selected to increase the quantity to be measured through aggregation, or to cover a wider area during a single measurement. In one example, the capacitance associated with a stack of coils may be measured as an aggregate. In another example, the capacitance of coils at different locations in a charging surface may be measured to enable rapid detection of a device to be charged that is placed on the charging surface serviced by the measured coils.

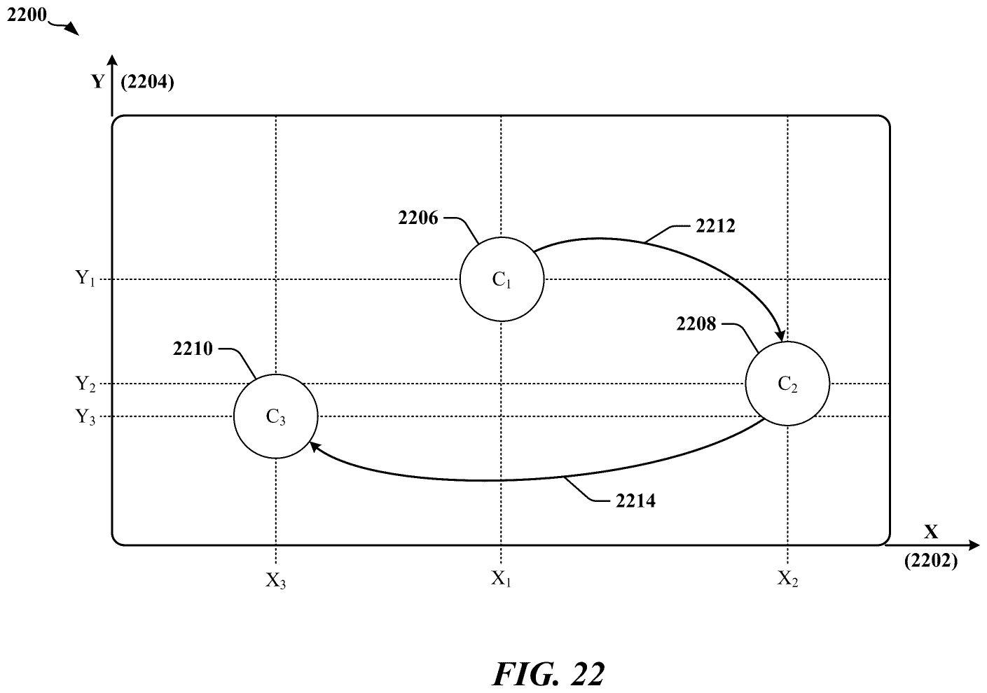

FIG. 22 illustrates certain aspects of searching for a chargeable device. The search may be conducted using differential capacitive sensing, analog ping, digital ping or some combination of capacitive sensing, analog ping and digital ping. FIG. 22 illustrates a two-dimensional view (X axis 2202 and Y axis 2204) of a charging surface 2200, which is provided with one or more charging cells that include the three illustrated charging coils 2206, 2208, 2210. Certain aspects illustrated by FIG. 22 are also applicable to searches involving individual coils within a charging coil 2206, 2208, 2210 or spread throughout a charging surface 2200 and/or in a three-dimensional space. In the illustrated example, the charging coils 2206, 2208, 2210 are the first three charging coils tested during a search, which may be conducted as a pseudorandom search. The search commences at a first charging coil 2206. The search pattern may cause testing to move 2212 to a second charging coil 2208, and may then cause testing to move 2214 to a third charging coil 2210. The search may be conducted to identify the general location of a receiving device and may be stopped when a measurement indicating presence of a receiving device is obtained. A second, area-specific search may then be conducted around the charging coil 2206, 2208, 2210.

A wireless charging system implemented in accordance with certain aspects of this disclosure can commence charging at the earliest opportunity. For example, charging may commence with a minimum delay after a chargeable device has been placed on a charging surface. In some implementations, searching and commencement of charging can be accelerated using a less-than-ideal charging configuration based on a first-located charging cell with sufficient coupling to enable power transmission. In one example, the sufficiency of coupling may be measured by efficiency of power transfer. For example, a sufficient coupling may be indicated when power received or captured by the chargeable device exceeds 5% or 10% of the power expended by the wireless charging system while transmitting power to the chargeable device. In many instances, low efficiency charging can be tolerated for the time necessary to identify a superior charging configuration.

In some implementation, presence, position and/or orientation of a receiving device can be determined using a combination of passive and active/digital pings. In some implementation, presence, position and/or orientation of a receiving device can be determined using sensors. For example, one or more sensors may be used to detect differences or changes in capacitance, resistance, inductance, touch, pressure, temperature, load, strain, and/or another physical quantity. Location sensing may be employed to indicate potential presence or location of an object or device to be charged. Location sensing may also be employed to detect removal of a receiving device during power transfer from a charging surface.

According to certain aspects of this disclosure, charging of a chargeable device can be accelerated by commencing device charging using the first charging cell that is discovered to have sufficient coupling with a chargeable device. In many instances, the optimal charging configuration may not be determinable when the first-discovered usable charging cell is used to transfer power. However, the search can be conducted by pausing power transmission for short durations of time to enable passive pings or active pings to be transmitted through other charging cells and/or other, adjacent transmitting coils. Using the first-discovered sufficiently-coupled charging cell can minimize the delay between placement of a chargeable device on a charging surface and commencement of charging.

According to one aspect, the search for chargeable devices can be converted to a search for an optimal charging configuration after charging has commenced using the first-discovered sufficiently-coupled charging cell. For the purposes of this description, the term “coupled charging cell” may be used to refer to a charging cell that includes one or more power transmitting coils that are electromagnetically coupled with a power receiving coil in the chargeable device to a sufficient degree that power can be transmitted to the chargeable device through the coupled charging cell. In some implementations, the search for an optimal charging configuration may be limited to searches based on passive pings. Typically, charging must be paused or terminated in order to transmit an active ping through a charging cell that is not being used for charging the cell.

In some implementations, the search for an optimal charging configuration may be limited to charging cells and/or power transmitting coils that are adjacent or close to the first-discovered sufficiently-coupled charging cell. An objective for the search for an optimal charging configuration may be to determine a charging cell or a power transmitting coil that has the best electromagnetic coupling with the power receiving coil in the chargeable device. In some implementations, the search for an optimal charging configuration may determine a charging cell or a power transmitting coil that has an optimal coupling with the power receiving coil in the chargeable device. In one example, a coupled charging cell may be determined to provide optimal coupling when it includes a power transmitting coil that has inferior electromagnetic coupling with a power receiving coil in comparison to another power transmitting coil, but is subject to lower electromagnetic interference from a different charging circuit. In another example, a coupled charging cell may be determined to provide optimal coupling when it includes a power transmitting coil that has inferior electromagnetic coupling with a power receiving coil in comparison to another power transmitting coil, but is subject to losses caused by a metallic or other foreign object. In some implementations, optimal coupling may be indicated by a change in resonant frequency of a resonant circuit that includes the power transmitting coil. In some implementations, optimal coupling may be indicated by an exchange of information between the wireless charging system and the chargeable device. For example, the chargeable device may report received power or current levels.

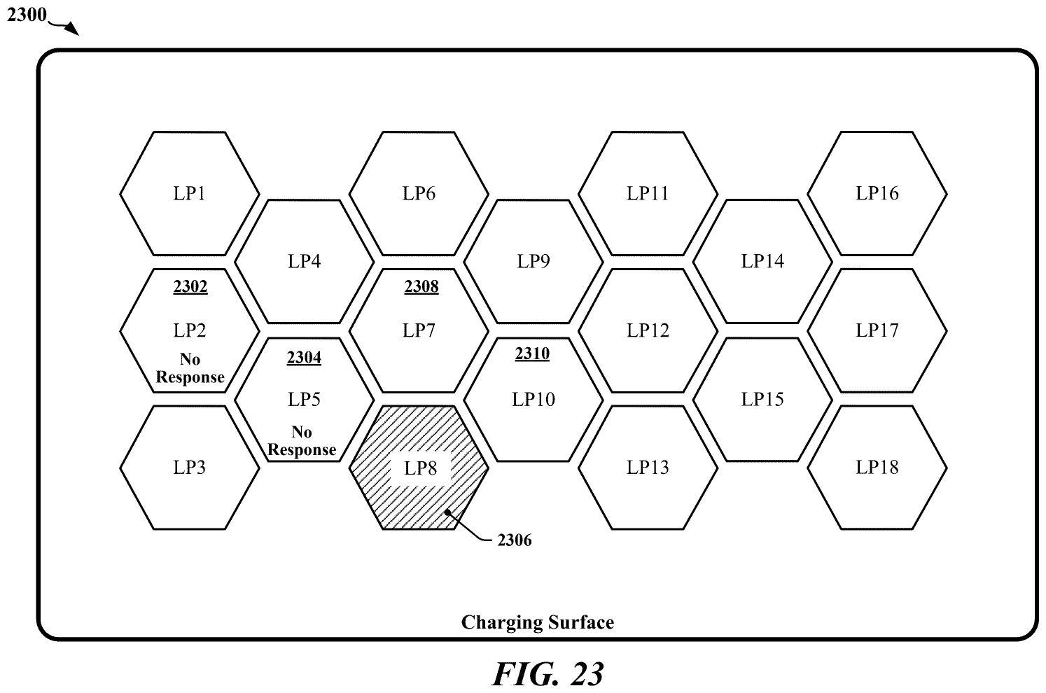

FIG. 23 illustrates certain aspects of a search of a charging surface 2300 in accordance with this disclosure. The charging surface 2300 may be provided by a wireless charging device that is configurable to drive multiple charging cells (LP1-LP18). In one example, each charging cell includes a Litz coil. For the purposes of illustration only, the charging surface 2300 is searched using a combination of analog pings and digital pings. Analog pings and digital pings may also be referred to as passive pings and active pings, respectively. Analog pings are transmitted from a transmitting circuit through charging cells to determine if a potential chargeable device is present on the charging surface 2300 in the vicinity of the charging cell. In one example, digital pings are implemented by transmitting an electromagnetic flux from the wireless charging system that the chargeable device can modulate by manipulating the impedance of its power receiving circuit. The chargeable device may encode information in a modulation signal used to modulate the electromagnetic flux transmitted by the wireless charging system. A digital ping may be sent through a transmitting coil identified when an analog ping indicates that a different charging cell can be used more efficiently and/or more optimally for transmitting power to a chargeable device. The transmitting circuit may correspond in some respects to the wireless transmitter 700 illustrated in FIG. 7.

In the illustrated example, a search for chargeable devices begins at the LP2 charging cell 2302 and proceeds diagonally through the LP5 charging cell 2304 and the LP8 charging cell 2306. An analog ping may be transmitted through each charging cell 2302, 2304, 2306 in turn. In other modes of searching, analog pings can be transmitted independently and concurrently through multiple charging cells. In the illustrated example, a response to the analog ping transmitted through the LP8 charging cell 2306 indicates that a chargeable device is located sufficiently near the LP8 charging cell 2306 that a power receiving coil in the chargeable device is electromagnetically coupled with a power transmitting coil in the LP8 charging cell 2306. In the example of the wireless transmitter 700 illustrated in FIG. 7, the analog ping may be transmitted through the resonant circuit 706 and the presence of an object with measurable magnetic susceptibility may alter the inductance and/or resonant frequency of the resonant circuit 706. In one example, the analog ping may reveal a resonant frequency of the resonant circuit 706 that is different from an expected or previously measured resonant frequency.

According to one aspect of this disclosure, the search for chargeable devices may be suspended while a digital ping is transmitted through the LP8 charging cell 2306. In some implementations, the search for chargeable devices may continue using other wireless transmitters in a different part of the charging surface 2300. The search may be resumed if a chargeable device does not respond to the digital ping. In the illustrated example, a chargeable device responds to the digital ping by modulating the electromagnetic flux transmitted through the LP8 charging cell 2306. The chargeable device may modulate the electromagnetic flux by altering the impedance of a power receiving circuit coupled to its power receiving coil. A processing circuit in the wireless charging device may generate a charging configuration using the LP8 charging cell 2306 and based on information received in the response to the digital ping. The wireless charging device may then commence charging of the chargeable device through the LP8 charging cell 2306 in accordance with the generated charging configuration.

According to one aspect of this disclosure, the search for chargeable devices may be at least temporarily converted to a search for an optimal charging configuration before or during charging of the chargeable device through the LP8 charging cell 2306. In some implementations, the search for an optimal charging configuration may be limited to charging cells 2304, 2308, 2310 that are adjacent to the LP8 charging cell 2306. In the illustrated example, an analog ping transmitted through the LP5 charging cell 2304 did not indicate presence of a chargeable device and the LP5 charging cell 2304 can be excluded from the search for an optimal charging configuration. The search for an optimal charging configuration may include transmitting an analog ping or a digital ping through the LP7 charging cell 2308 and the LP10 charging cell 2310, since the LP5 charging cell 2304 has already been used to transmit an analog ping.

In some examples, an analog ping may be transmitted through the LP7 charging cell 2308 and the LP10 charging cell 2310 to determine if these adjacent charging cells 2308, 2310 have better electromagnetic coupling than the LP10 charging cell 2310. If the LP8 charging cell 2306 has the best electromagnetic coupling, then the charging configuration generated for use with the LP8 charging cell 2306 is retained and the search for chargeable devices may be resumed, using a different wireless transmitter. The search for an optimal configuration may be extended if either the LP7 charging cell 2308 or the LP10 charging cell 2310 is discovered to provide better electromagnetic coupling with the power receiving coil in the chargeable device. For example, the search for an optimal configuration may be extended to include charging cells adjacent to the LP7 charging cell 2308 or the LP10 charging cell 2310.

Upon completion of the search for an optimal configuration, an updated charging configuration may be generated using the charging cell that is determined to provide optimal coupling with the power receiving coil in the chargeable device. In some instances, multiple charging cells may be used in accordance with the updated charging configuration. In some instances, charging of the chargeable device through the LP8 charging cell 2306 may be terminated and charging restarted based on the updated charging configuration. A charging configuration may define one or more charging cells to be used for charging the chargeable device, one or more wireless power transmitters to be used for charging the chargeable device, a frequency of the electromagnetic flux to be transmitted and a level of power to be transmitted. The frequency of the electromagnetic flux to be transmitted and/or the level of power to be transmitted may be controlled by configuring the current provided to a tank circuit in each wireless power transmitter selected for charging the chargeable device.

In some implementations, the updated charging configuration may be generated by reconfiguring a charging cell to include some combination of power transmitting coils that have been determined to provide optimal coupling with the power receiving coil in the chargeable device. In some instances, charging of the chargeable device through the LP8 charging cell 2306 may be terminated and charging restarted based on the updated charging configuration. A charging configuration may define one or more power transmitting coils to be used for charging the chargeable device, one or more wireless power transmitters to be used for charging the chargeable device, a frequency of the electromagnetic flux to be transmitted and a level of power to be transmitted. The frequency of the electromagnetic flux to be transmitted and/or the level of power to be transmitted may be controlled by configuring the current provided to a tank circuit in each wireless power transmitter selected for charging the chargeable device.

According to certain aspects of this disclosure, the coupling between power transmitting coils and the power receiving coil in the chargeable device may be compared or classified by assessing signal strengths measured or detected in the chargeable device, the signal strength of modulation signals detected in a tank circuit of a wireless power transmitter, and/or information received in a digital ping procedure. Signal strengths may be determined before charging commences. Signal strengths may be determined for idle charging cells or power transmitting coils while charging is in progress through one or more active charging cells or power transmitting coils.

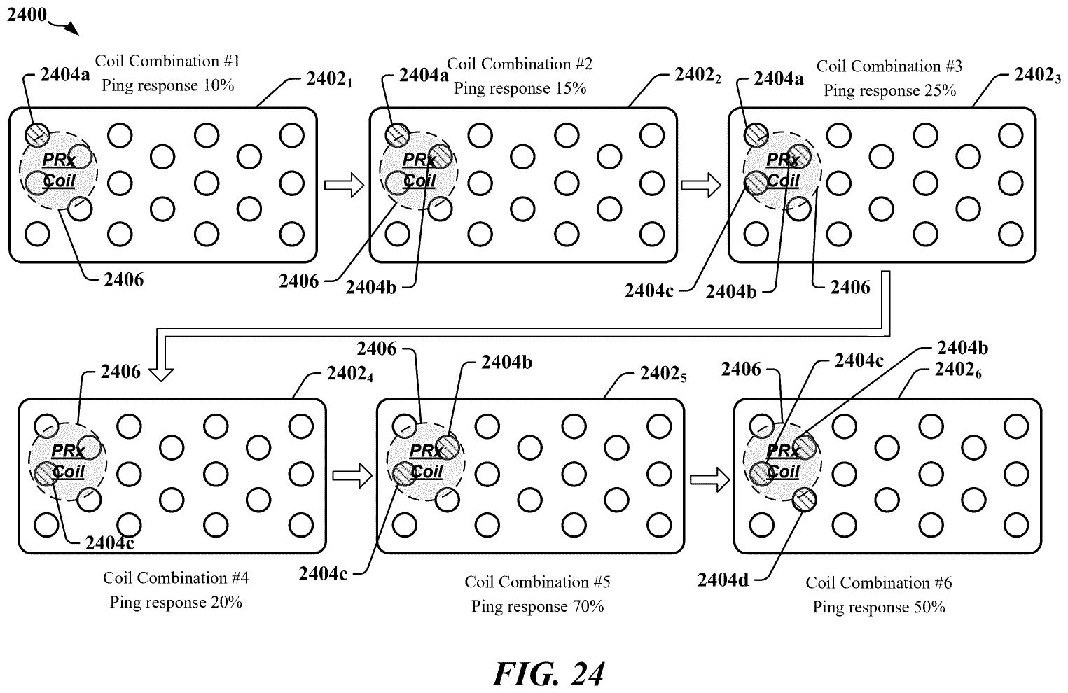

FIG. 24 illustrates an example 2400 of an apparatus applying a charging cell selection methodology according to some aspects. In particular, the methodology illustrated in example 2400 is used to select a combination of charging coils that have the highest signal strength through the use of both passive (or analog) pings and active (or digital) pings. In a particular aspect, the disclosed methodology provides a selection of a combination of charging coils that provide yield a strongest ping or, in other words, a combination of multiple coils that provides the best connection for a receiving device (PRx).

In this example, a wireless changing surface 2402 includes a number of coils 2404 similar to the example of FIG. 23 (e.g., coils LP1-LP18), except that the coils are represented as a circle geometry for sake of simplicity. In particular, when a power receiver (PRx) 2406 is placed in proximity with the charging surface 2402, and one or more charging coils 2404 are capable of effecting pinging of the PRx 2406 the methodology includes pinging each of a number of possible combinations of coils 2404. In the example of FIG. 24, each of the various possible coil combinations are illustrated by a number of different illustrations of the charging surface (i.e., 2402₁, 2402₂, 2402₃, 2402₄, 2402₅, 2402₆) each showing a different potential coil combinations.

As illustrated by the option denoted by 2402₁, a single activated coil 2404a (an activated coil being indicated by shading) is used to ping the PRx 2406. In a next option denoted by 2402₂, two coils 2404a and 2404b are activated by the wireless charging device to ping the PRx 2406. In yet a next option denoted by 2402₃, three coils 2404a, 2404b, and 2404c are activated to ping the PRx 2406, and so forth for the remainder of the six potential combinations illustrated by 2402₄, 2402₅, and 2402₆. In this particular example, it is noted that the first combination shown by 2402₁, the activated coil 2404a is only partially covered by PR 2406 and the ping response might be a percentage of a maximum possible or expected response power level or as a percentage of transmitted power. In the particular example illustrated in FIG. 24, the ping response may be 10% of transmitted power, for example. In another coil combination having three activated coils 2404a, 2404b, and 2404c as shown at 2402₃, for example, the ping response may be higher at 25%. As illustrated in FIG. 24, the various different combinations have differing levels of ping response, and the selection method may analyze the different ping response levels for all of the possible coil combinations and then select the highest or strongest ping response. In the example of FIG. 24, the coil combination shown at 2402₅ would have the strongest ping response and this coil combination may be selected. As will be described below, the selection may involve the use of one or both of analog (passive) and digital (active) pings to more quickly determine the coil combination having the highest ping response for a particular PRx and its location on the charging surface. It is noted that for the example of FIG. 24, the combination of coils 2404b and 2404c as shown at 2402₅ having a ping response of 70% would be selected as this combination has the highest ping response. This is merely exemplary, however, and the disclosure is not intended to be limited to any particular values or percentages.

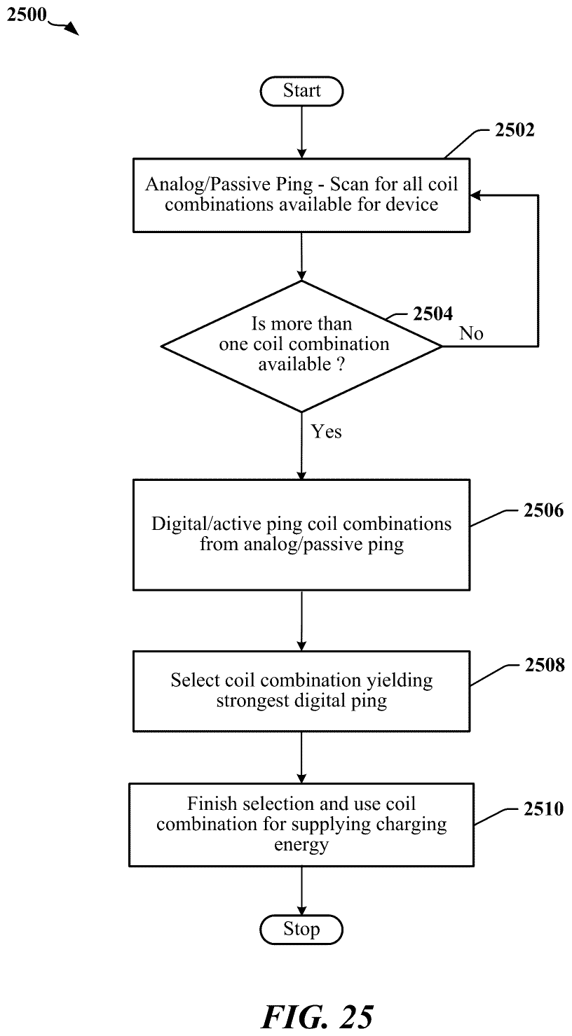

FIG. 25 illustrates an example of a method 2500 for ping selection using both analog and digital pings for a best coil combination selection in a wireless charging device according to some aspects of the present disclosure. In the illustrated example of method 2500, the method starts with analog (passive) pinging of the various coils in the wireless charging device in order to determine possible combinations for a PRx device on the charging surface (e.g., 2402) as shown at block 2502. In particular example, the wireless charging device may be configured to ping all possible coil combinations using analog or passive pings.

Since analog pings are generally quicker than digital pings, initial analog pinging allows the wireless charging device to more quickly determine where the PRx device is located on the charging surface as well as more quickly identify the potential coil combinations to be analyzed. In one aspect, the process in block 2502 may involve determining all coils that generate a ping response from the PRx to, in turn, be able to examine all possible combinations of those coils that yield a ping response. In other aspects, a threshold could be predefined such that only those coils receiving a ping response above the predetermined level among the set of all coils yielding a ping response could be used for the initial determination of the possible coil combinations.

After the scan of either all or a suitable subset of possible combinations is determined in block 2502, flow proceeds to decision block 2504 where a determination is made whether there are at least two different coil combinations available to select from. If not, then the need for selection is nonexistent or superfluous and flow returns to block 2502 to continue scanning for pings and attendant coil combinations for any receiving devices (PRx) or, if the receiving device PRx is subsequently moved, then scanning for multiple coil combinations that might develop after the PRx is moved.

If there are multiple available coil combinations as determined at block 2504, flow proceeds to block 2506 where digital pinging is performed for the various coil combinations determined in block 2502. In one example, the digital ping may be performed for all of the possible combinations identified in block 2502. According to another example, only those coil combinations that qualified to meet the predefined threshold may be digital pinged in the process of block 2506.

After digital pinging of the coil combinations in block 2506, a coil (in the case of a single coil such as may be seen at 2402₁) or coil combination having the highest or strongest digital ping is selected as shown at block 2508. After selection is made, the method 2500 may end as the selection is complete and the selected coil combination is then used for supplying charging energy for the PRx (e.g., 2406) as shown at block 2510. The selected coil combination may then be used to provide charging energy to the PRx device.

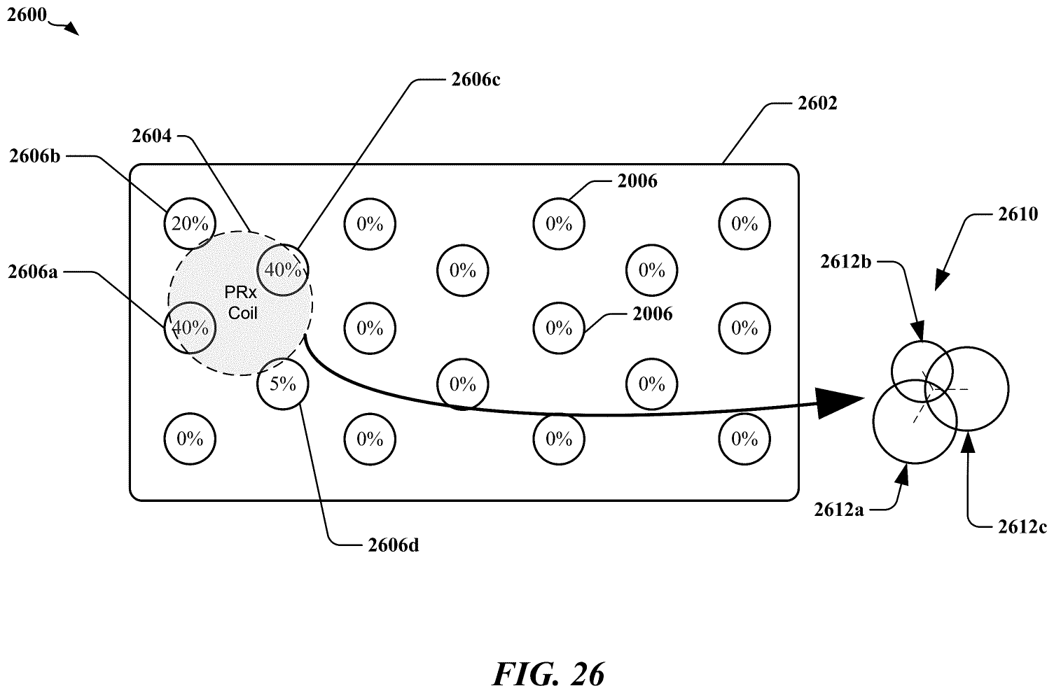

FIG. 26 illustrates another example 2600 of a coil selection methodology where each individual coil in a wireless charging is activated, one at a time, in order to determine a location of receiver (PRx). As illustrated, a wireless charging device may have a charging surface 2602 having a receiving device (e.g., PRx coil) 2604 located in proximity thereto. In order to determine location of the PRx 2604, each individual coil 2606 may be activated to ping the PRx coil 2604, and then a relative strength is determined. For example, FIG. 26 illustrates that most of the coils 2606 will have a relative ping strength of 0% as most are not located near enough to PRx coil 2604 to yield a ping response. In this example, four coils 2606a, 2606b, 2606c, and 2606d are in close enough proximity to receive a ping response from PRx coil 2604 when pinging. As further illustrated in this example 2600, each coil has a relative strength value or percentage that indicates the strength of the ping response from PRx 2604 when the coil sends a ping. As merely exemplary numbers for the sake of illustration, coil 2606a has a relative strength of 40%, coil 2606b has a relative strength of 20%, coil 2606c has a relative strength of 40%, and coil 2606d has a relative strength of 5%, In an example, it is noted that the initial ping determinations for each coil 2606 may be performed using analog/passive pinging in order to implement this process more quickly. Additionally, it is noted that the analog pinging process may also not necessarily measure relative strength, but merely to identify those coils of wireless charging surface 2602 having a ping response.

Once all of the coils 2606 having a ping response (or a ping strength response above a predetermined threshold in other examples) have been identified, a digital ping of those identified coils may then be performed, again one at time, although not necessarily limited to such. In this example, the digital ping may be limited to only those coils identified as having a ping response from an analog/passive ping scan of all of the coils in charging surface 2602. The relative strengths may be determined from the digital ping (or the previously determined relative strengths from the analog scan may be refined to increase the accuracy).

Based on the measured or determined relative strengths, a location of the PRx 2604 may be determined through calculation using geometric or other mathematical techniques (e.g., triangulation) to determine location of the PRx 2604. As an example, FIG. 26 illustrates a visual illustration 2610 of a triangulation that may be performed. In this illustration, the relative strengths and locations of coils 2606a, 2606b, and 2606c may be used to make the triangulation calculations. Additionally, the relative strengths may be accounted for as illustrated by the relative sizes for the contributions of coils 2606a, 2606b, and 2606c as shown at 2612a, 2612b, and 2612c. Based on the calculation, an optimal coil or group/combination of coils may be selected by wireless charging device.

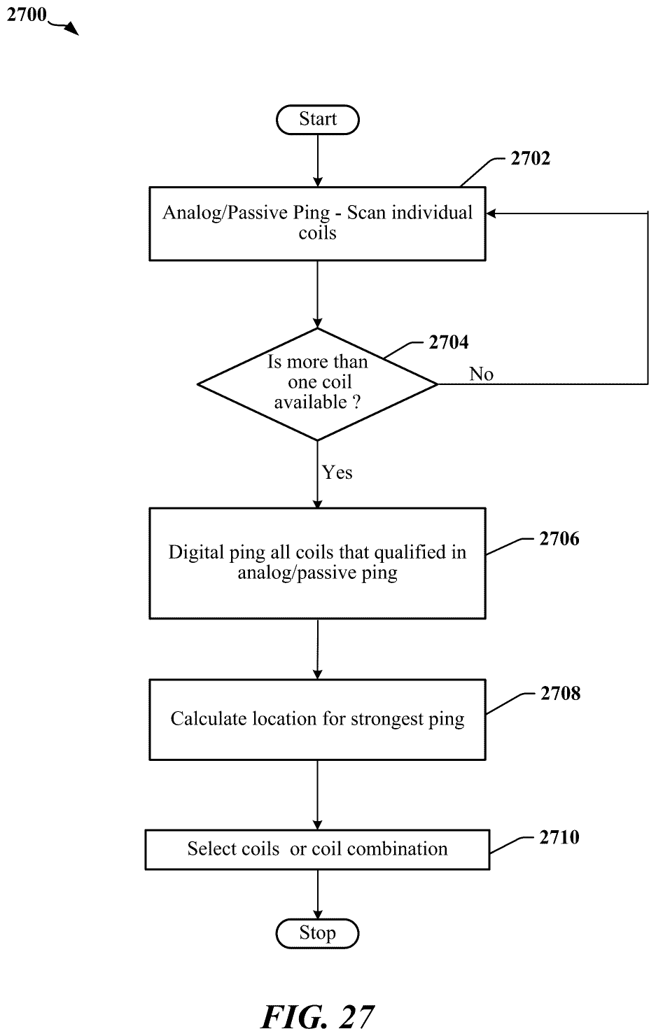

FIG. 27 illustrates a flow chart 2700 illustrating the methodology discussed above in for wireless changing in connection with the example disclosed in FIG. 26. In block 2702, a scanning ping of all coils is performed on an individual basis (i.e., one at a time), as was discussed above in connection with FIG. 26. In certain aspects, the scan in block 2702 may be performed using analog or passive ping techniques. In other examples, the scan in block 2702 may include measuring or determining the relative strength for the coils that yield a ping response from a receiver device (PRx) in proximity to the wireless charging device.

After performing the scan in block 2702, flow proceeds to decision block 2704 to determine if the device has more than one coil available based on scan results of block 2702. If not, a need for coil selection is nonexistent and flow proceeds back to block 2702. On the other if two or more coils were determined as yield a response to the pings, flow proceeds to block 2706. In this block, a digital ping by those coils identified at block 2702 may be performed. In an aspect, the process represented by block 2706 may again be performed one coil at a time. Furthermore, block 2706 may include determining the relative strength, such as with a value or percentage as illustrated in FIG. 26. The result of block 2706 will then yield two or more relative strengths of the identified coils based on digital ping. From this information a location of the PRx device (e.g., 2604) may be calculated as shown in block 2708. In particular, the calculation may use a trigonometric triangulation calculation as one example, and further the relative strengths may be accounted for in the calculation such as through a weighting of relative strengths. The method illustrated by the flow chart 2700 may then include selection of one or more coils (e.g., a coil combination) for supplying charging energy to the PRx device as shown at block 2710.

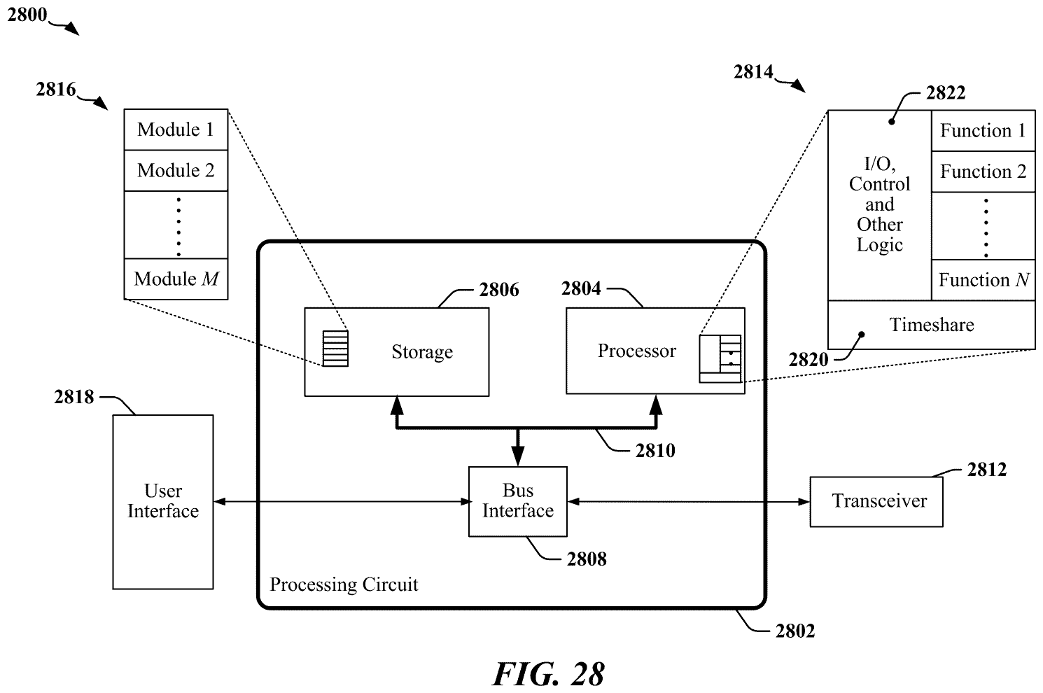

FIG. 28 illustrates an example of a hardware implementation for an apparatus 2800 that may be incorporated in a charging device that enables a battery to be wirelessly charged. In some examples, the apparatus 2800 may perform one or more functions disclosed herein. In accordance with various aspects of the disclosure, an element, or any portion of an element, or any combination of elements as disclosed herein may be implemented using a processing circuit 2802. The processing circuit 2802 may include one or more processors 2804 that are controlled by some combination of hardware and software modules. Examples of processors 2804 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2804 may include specialized processors that perform specific functions, and that may be configured, augmented or controlled by one of the software modules 2816. The one or more processors 2804 may be configured through a combination of software modules 2816 loaded during initialization, and further configured by loading or unloading one or more software modules 2816 during operation.

In the illustrated example, the processing circuit 2802 may be implemented with a bus architecture, represented generally by the bus 2810. The bus 2810 may include any number of interconnecting buses and bridges depending on the specific application of the processing circuit 2802 and the overall design constraints. The bus 2810 links together various circuits including the one or more processors 2804, and storage 2806. Storage 2806 may include memory devices and mass storage devices, and may be referred to herein as computer-readable media and/or processor-readable media. The storage 2806 may include transitory storage media and/or non-transitory storage media.

The bus 2810 may also link various other circuits such as timing sources, timers, peripherals, voltage regulators, and power management circuits. A bus interface 2808 may provide an interface between the bus 2810 and one or more transceivers 2812. In one example, a transceiver 2812 may be provided to enable the apparatus 2800 to communicate with a charging or receiving device in accordance with a standards-defined protocol. Depending upon the nature of the apparatus 2800, a user interface 2818 (e.g., keypad, display, speaker, microphone, joystick) may also be provided, and may be communicatively coupled to the bus 2810 directly or through the bus interface 2808.

A processor 2804 may be responsible for managing the bus 2810 and for general processing that may include the execution of software stored in a computer-readable medium that may include the storage 2806. In this respect, the processing circuit 2802, including the processor 2804, may be used to implement any of the methods, functions and techniques disclosed herein. The storage 2806 may be used for storing data that is manipulated by the processor 2804 when executing software, and the software may be configured to implement any one of the methods disclosed herein.

One or more processors 2804 in the processing circuit 2802 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2806 or in an external computer-readable medium. The external computer-readable medium and/or storage 2806 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2806 may also include, by way of example, a carrier wave, a transmission line, and any other suitable medium for transmitting software and/or instructions that may be accessed and read by a computer. Computer-readable medium and/or the storage 2806 may reside in the processing circuit 2802, in the processor 2804, external to the processing circuit 2802, or be distributed across multiple entities including the processing circuit 2802. The computer-readable medium and/or storage 2806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2806 may maintain and/or organize software in loadable code segments, modules, applications, programs, etc., which may be referred to herein as software modules 2816. Each of the software modules 2816 may include instructions and data that, when installed or loaded on the processing circuit 2802 and executed by the one or more processors 2804, contribute to a run-time image 2814 that controls the operation of the one or more processors 2804. When executed, certain instructions may cause the processing circuit 2802 to perform functions in accordance with certain methods, algorithms and processes described herein.

Some of the software modules 2816 may be loaded during initialization of the processing circuit 2802, and these software modules 2816 may configure the processing circuit 2802 to enable performance of the various functions disclosed herein. For example, some software modules 2816 may configure internal devices and/or logic circuits 2822 of the processor 2804, and may manage access to external devices such as a transceiver 2812, the bus interface 2808, the user interface 2818, timers, mathematical coprocessors, and so on. The software modules 2816 may include a control program and/or an operating system that interacts with interrupt handlers and device drivers, and that controls access to various resources provided by the processing circuit 2802. The resources may include memory, processing time, access to a transceiver 2812, the user interface 2818, and so on.

One or more processors 2804 of the processing circuit 2802 may be multifunctional, whereby some of the software modules 2816 are loaded and configured to perform different functions or different instances of the same function. The one or more processors 2804 may additionally be adapted to manage background tasks initiated in response to inputs from the user interface 2818, the transceiver 2812, and device drivers, for example. To support the performance of multiple functions, the one or more processors 2804 may be configured to provide a multitasking environment, whereby each of a plurality of functions is implemented as a set of tasks serviced by the one or more processors 2804 as needed or desired. In one example, the multitasking environment may be implemented using a timesharing program 2820 that passes control of a processor 2804 between different tasks, whereby each task returns control of the one or more processors 2804 to the timesharing program 2820 upon completion of any outstanding operations and/or in response to an input such as an interrupt. When a task has control of the one or more processors 2804, the processing circuit is effectively specialized for the purposes addressed by the function associated with the controlling task. The timesharing program 2820 may include an operating system, a main loop that transfers control on a round-robin basis, a function that allocates control of the one or more processors 2804 in accordance with a prioritization of the functions, and/or an interrupt driven main loop that responds to external events by providing control of the one or more processors 2804 to a handling function.

In one implementation, the apparatus 2800 includes or operates as a wireless charging device that has a battery charging power source coupled to a charging circuit, a plurality of charging cells and a controller, which may be included in or implemented with one or more processors 2804. The plurality of charging cells may be configured to provide a charging surface. At least one coil may be configured to direct an electromagnetic field through a charge transfer area of each charging cell. The controller may be configured to cause the charging circuit to provide a charging current to a resonant circuit when a receiving device is placed on the charging surface, detect a change or rate of change in voltage or current level associated with the resonant circuit or a change or rate of change in power transferred to the receiving device, and determine that the receiving device has been removed from the charging surface when the change or rate of the change in voltage or current level or change or rate of change in power transferred to the receiving device exceeds a threshold value.

In some implementations, the resonant circuit includes a transmitting coil. The controller may be further configured to determine that the receiving device has been removed from the charging surface when a voltage measured at a terminal of the transmitting coil exceeds a threshold voltage level. In one example, the threshold voltage level is maintained by a lookup table and determined when the transmitting coil is electromagnetically uncoupled. In another example, the threshold voltage level is determined when the receiving device is first placed on the charging surface.

In certain implementations, the controller is further configured to cause a transmitting coil to issue a ping that may be received by a power receiving device (e.g., PRx) in proximity to wireless charging device (e.g., disposed on the wireless charging surface). Additionally, the transmitting coil may be configured to receive a ping reply such as an ASK modulated reply from the power receiving device (PRx). Additionally, the measured in the resonant circuit has a magnitude that is less than a threshold current level. In one example, the threshold current level is maintained by a lookup table and determined when no object is electromagnetically coupled with a coil in the resonant circuit. In another example the threshold current level is determined when the receiving device is first placed on the charging surface.

In some implementations, the apparatus 2800 has one or more sensors located proximate to an exterior surface of the charging device. The controller may be further configured to receive measurements from the one or more sensors, and measure the voltage or current level associated with the resonant circuit when one of the measurements indicates physical removal of the receiving device. The sensors may include a strain measuring sensor, an accelerometer, an infrared or ultrasonic sensing element and/or a hall-effect device.

In some implementations, the storage 2806 maintains instructions and information where the instructions are configured to cause the one or more processors 2804 to. send one or more pings from a plurality of charging coils (or charging cells having at least one charging coil) in the wireless charging device using an analog ping process to scan for one or more ping responses from a receiving device in proximity to the wireless charging device. In particular, this function of sending of pings may be include the processes in blocks 2502 or 2702 in FIGS. 25 and 27, for either scanning using individual coils or groups/combinations of coils.

Additionally, the storage 2806 maintains instructions and information where the instructions are configured to cause the one or more processor 2804 to determine a subset of charging coils of the plurality of charging coils in the wireless device that received ping responses from the receiving device in response to the sending of pings with the analog process. As an example, this function may include the processes in blocks 2504 or 2704, where the ping responses from analog or passive pinging is used by the processor 2804 determine potential coils to be subsequently used for digital pinging of the identified potential coils (i.e., the subset of charging of coils).

In further implementations, the storage 2806 maintains instructions and information where the instructions are configured to cause the one or more processor 2804 to send one or more pings from an identified subset of charging coils (i.e., coils or combinations of coils receiving ping responses from the receiving device) using a digital ping process. As an example, this function may include the processes in blocks 2506 or 2706 where the qualified coil groups/combinations or individual coils are pinged using a digital (active) ping process as was discussed in connection with FIGS. 24-27. Additionally, the storage 2806 maintains instructions and information where the instructions are configured to cause the one or more processor 2804 to select a combination of one or more charging coils of the subset of charging coils based on ping responses from the receiving device in response to the digital ping process. Examples of this function may include the processes of blocks 2508 or 2708.

In one example implementation, an apparatus includes means for transferring power through a charging surface, means for searching for a chargeable device and processing means. The means for transferring power through the charging surface may be configured to concurrently charge multiple chargeable devices. The means for transferring power may include one or more power transmitting circuits. The means for searching for the chargeable device may include means for transmitting analog pings and means for transmitting digital pings. The processing means may include the processing circuit 2802. The processing means may be configured to initiate a search for a chargeable device by causing a first transmitting circuit to transmit analog pings through power transmitting coils associated with the charging surface, suspend the search for the chargeable device when a response to an analog ping transmitted through a first power transmitting coil indicates that an object is located in proximity to the wireless charging device, cause the first transmitting circuit to transmit a first digital ping through the first power transmitting coil, transmit power through the first power transmitting coil when a response to the first digital ping is received, resume the search for the chargeable device using analog pings, and transmit power through a second power transmitting coil when a response to a second digital ping indicates that more efficient power transfer is available through the second power transmitting coil.

In certain implementations, power transmission through the first power transmitting coil is terminated when power transmission through the second power transmitting coil commences.

In certain implementations, the search for the chargeable device is resumed by suspending power transmission through the first power transmitting coil when a second analog ping is transmitted through one or more other power transmitting coils.

In certain implementations, resuming the search for the chargeable device includes transmitting one or more digital pings through a second transmitting circuit.

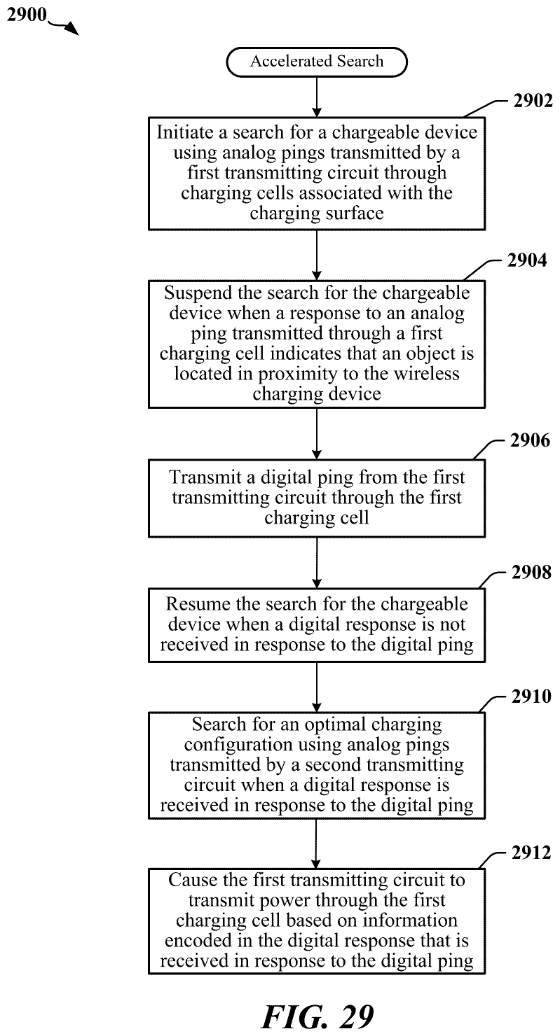

FIG. 29 is a flowchart illustrating a method 2900 for searching a charging surface of a wireless charging device in accordance with certain aspects of this disclosure. The method 2900 may be performed by a controller in the wireless charging device. At block 2902, the controller may initiate a search for a chargeable device using analog pings transmitted by a first transmitting circuit through charging cells associated with the charging surface. At block 2904, the controller may suspend the search for the chargeable device when a response to an analog ping transmitted through a first charging cell indicates that an object is located in proximity to the wireless charging device. At block 2906, the controller may transmit a digital ping from the first transmitting circuit through the first charging cell. At block 2908, the controller may resume the search for the chargeable device when a digital response is not received in response to the digital ping. At block 2910, the controller may search for an optimal charging configuration using analog pings transmitted by a second transmitting circuit when a digital response is received in response to the digital ping. At block 2912, the controller may cause the first transmitting circuit to transmit power through the first charging cell based on information encoded in the digital response that is received in response to the digital ping.

In certain implementations, searching for the optimal charging configuration includes comparing a strength value of an analog ping response for each of a plurality of different charging cells with a strength value of the response to the analog ping transmitted through the first charging cell, and generating the optimal charging configuration based on ping response strength. Power transmission through the first charging cell may be terminated when the optimal charging configuration is generated. The controller may cause the first transmitting circuit to transmit power in accordance with the optimal charging configuration.

In some examples, each charging cell comprises a Litz coil. In some examples, each charging cell includes multiple power transmitting coils.

In some implementations, the response to the analog ping transmitted through the first charging cell that indicates that an object is located in proximity to the wireless charging device includes a change in resonant frequency of a tank circuit in the first transmitting circuit. The response to the analog ping transmitted through the first charging cell that indicates that an object is located in proximity to the wireless charging device may include a change in inductance of a tank circuit in the first transmitting circuit.

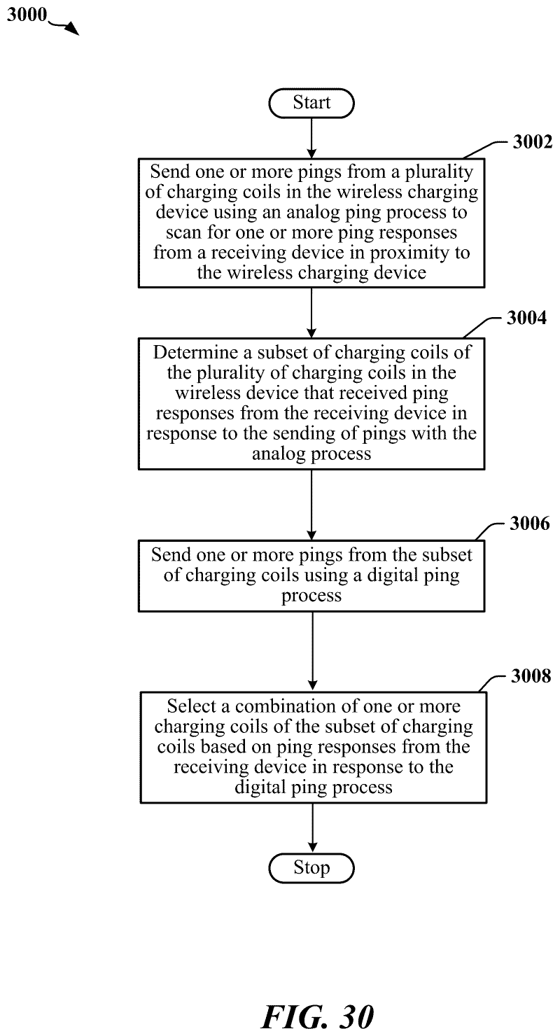

FIG. 30 is a flowchart illustrating a method 3000 for operating a charging device in accordance with certain aspects of this disclosure. The method 3000 may be performed by a controller in the charging device. At block 3002, the controller may send one or more pings from a plurality of charging coils in the wireless charging device using an analog ping process to scan for one or more ping responses from a receiving device in proximity to the wireless charging device.

Additionally, method 3000 includes determining a subset of charging coils of the plurality of charging coils in the wireless device that received ping responses from the receiving device in response to the sending of pings with the analog process as shown in block 3004. The processes of block 3004 may include determining the subset from either scanning coil combinations as was discussed in the example of FIGS. 24 and 25 or individual coils as was discussed in the example of FIGS. 26 and 27.

Further, method 3000 may include sending pings from the subset of charging coils using a digital ping process as shown at block 3006. This process in block 3006 may include sending digital or active pings using combinations as in the example of FIGS. 24 and 25 or using individual coils as was discussed in the example of FIGS. 26 and 27.

Moreover, method 3000 includes selecting a combination of one or more charging coils of the subset of charging coils based on ping responses from the receiving device in response to the digital ping process as shown at block 3008. It is noted here that the selections of one or more coils may be achieved through the scanning of combinations as in the example of FIGS. 24 and 25 or using digital pings from individuals coils and then mathematically calculating which coils could be combined as was discussed in the example of FIGS. 26 and 27. Thus, in one example method 3000 provides for selection of an optimized combination of coils to provide charging for a receiving device by either pinging from selected variations of a combination of coils and deciding which is optimal from the observed ping responses, or from individual coil ping strengths and then mathematically determining the optimal coil combination from the individual ping strengths.

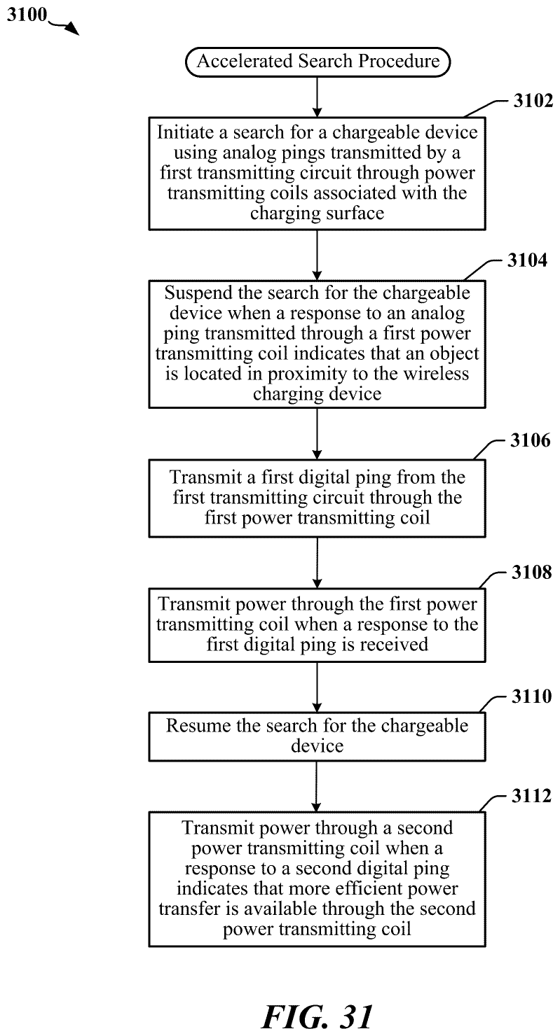

FIG. 31 is a flowchart illustrating an accelerated search method 3100 that may be used to search a charging surface of a wireless charging device in accordance with certain aspects of this disclosure. The method 3100 may be performed by a controller in the wireless charging device. At block 3102, the controller may initiate a search for a chargeable device using analog pings transmitted by a first transmitting circuit through power transmitting coils associated with the charging surface. In certain implementations, each power transmitting coil comprises a plurality of coils. In some implementations, each power transmitting coil comprises a Litz coil. At block 3104, the controller may suspend the search for the chargeable device when a response to an analog ping transmitted through a first power transmitting coil indicates that an object is located in proximity to the wireless charging device. At block 3106, the controller may transmit a first digital ping from the first transmitting circuit through the first power transmitting coil. At block 3108, the controller may commence transmission of power through the first power transmitting coil when a response to the first digital ping is received. At block 3110, the controller may resume the search for the chargeable device. The search may be resumed while power transfer is being continually transmitted to the chargeable device. At block 3112, the controller may commence transmission of power through a second power transmitting coil when a response to a second digital ping indicates that more efficient power transfer is available through the second power transmitting coil.

In one example, information encoded in the response to the second digital ping indicates that more efficient power transfer is available through the second power transmitting coil. In another example, a difference between information encoded in the response to the first digital ping and information encoded in the response to the second digital ping indicates that more efficient power transfer is available through the second power transmitting coil.

In some instances, power transmission through the first power transmitting coil is terminated when power transmission through the second power transmitting coil commences.

In certain implementations, resuming the search for the chargeable device includes suspending power transmission through the first power transmitting coil when a second analog ping is transmitted through one or more other power transmitting coils. Resuming the search for the chargeable device may include transmitting one or more analog pings through a second transmitting circuit. Resuming the search for the chargeable device may include suspending power transmission through the first power transmitting coil when a third digital ping is transmitted through a third power transmitting coil. Resuming the search for the chargeable device may include transmitting one or more digital pings through a second transmitting circuit.

In certain implementations, an optimal charging configuration may be generated based on digital ping response strength. In certain implementations, the optimal charging configuration may be generated based on information encoded in the response to the first digital ping or based on information encoded in the response to the second digital ping.

In certain implementations, signal strength of responses to analog ping transmitted by each of a plurality of power transmitting coils is compared, and a charging configuration may be generated to use a power transmitting coil in the plurality of power transmitting coils that has a strongest ping response strength.

In some examples, responses to analog pings that indicate that an object is located in proximity to the wireless charging device are associated with changes in resonant frequency of a tank circuit in the first transmitting circuit. In some examples, responses to analog pings that indicate that an object is located in proximity to the wireless charging device are associated with changes in inductance of a tank circuit in the first transmitting circuit.

Some implementation examples are described in the following numbered clauses:
1. A method for searching a charging surface of a wireless charging device, comprising: initiating a search for a chargeable device using analog pings transmitted by a first transmitting circuit through power transmitting coils associated with the charging surface; suspending the search for the chargeable device when a response to an analog ping transmitted through a first power transmitting coil indicates that an object is located in proximity to the wireless charging device; transmitting a first digital ping from the first transmitting circuit through the first power transmitting coil; transmitting power through the first power transmitting coil when a response to the first digital ping is received; resuming the search for the chargeable device using analog pings; and transmitting power through a second power transmitting coil when a response to a second digital ping indicates that more efficient power transfer is available through the second power transmitting coil.
2. The method as described in clause 1, wherein power transmission through the first power transmitting coil is terminated when power transmission through the second power transmitting coil commences.
3. The method as described in clause 1 or clause 2, wherein information encoded in the response to the second digital ping indicates that more efficient power transfer is available through the second power transmitting coil.
4. The method as described in any of clauses 1-3, wherein a difference between information encoded in the response to the first digital ping and information encoded in the response to the second digital ping indicates that more efficient power transfer is available through the second power transmitting coil.
5. The method as described in any of clauses 1-4, wherein resuming the search for the chargeable device comprises: suspending power transmission through the first power transmitting coil when a second analog ping is transmitted through one or more other power transmitting coils.
6. The method as described in any of clauses 1-5, wherein resuming the search for the chargeable device comprises transmitting one or more analog pings through a second transmitting circuit.
7. The method as described in any of clauses 1-6, wherein resuming the search for the chargeable device comprises: suspending power transmission through the first power transmitting coil when a third digital ping is transmitted through a third power transmitting coil.
8. The method as described in any of clauses 1-7, wherein resuming the search for the chargeable device comprises transmitting one or more digital pings through a second transmitting circuit.
9. The method as described in any of clauses 1-8, wherein each power transmitting coil comprises a plurality of coils.
10. The method as described in any of clauses 1-9, further comprising: generating an optimal charging configuration based on digital ping response strength.
11. The method as described in any of clauses 1-10, further comprising: generating an optimal charging configuration based on information encoded in the response to the first digital ping or based on information encoded in the response to the second digital ping.
12. The method as described in any of clauses 1-11, further comprising: comparing signal strength of responses to analog ping transmitted by each of a plurality of power transmitting coils; and generating a charging configuration using a power transmitting coil in the plurality of power transmitting coils that has a strongest ping response strength.
13. The method as described in any of clauses 1-12, wherein each power transmitting coil comprises a Litz coil.
14. The method as described in any of clauses 1-13, wherein responses to analog pings that indicate that an object is located in proximity to the wireless charging device comprise changes in resonant frequency of a tank circuit in the first transmitting circuit.
15. The method as described in any of clauses 1-14, wherein responses to analog pings that indicate that an object is located in proximity to the wireless charging device comprise changes in inductance of a tank circuit in the first transmitting circuit
16. An apparatus comprising: means for transferring power through a charging surface of a wireless charging device to one or more chargeable devices, including one or more transmitting circuits; means for searching for a chargeable device, including means for transmitting analog pings and means for transmitting digital pings; processing means configured to: initiate a search for a chargeable device by causing a first transmitting circuit to transmit analog pings through power transmitting coils associated with the charging surface; suspend the search for the chargeable device when a response to an analog ping transmitted through a first power transmitting coil indicates that an object is located in proximity to the wireless charging device; causing the first transmitting circuit to transmit a first digital ping through the first power transmitting coil; transmit power through the first power transmitting coil when a response to the first digital ping is received; and resume the search for the chargeable device using analog pings; and transmit power through a second power transmitting coil when a response to a second digital ping indicates that more efficient power transfer is available through the second power transmitting coil.
17. The apparatus as described in clause 16, wherein power transmission through the first power transmitting coil is terminated when power transmission through the second power transmitting coil commences.
18. The apparatus as described in clause 16 or clause 17, wherein the search for the chargeable device is resumed by suspending power transmission through the first power transmitting coil when a second analog ping is transmitted through one or more other power transmitting coils.
19. The apparatus as described in any of clauses 16-18, wherein resuming the search for the chargeable device comprises transmitting one or more digital pings through a second transmitting circuit.
20. A processor-readable storage medium comprising code for: initiating a search for a chargeable device using analog pings transmitted by a first transmitting circuit through power transmitting coils associated with a charging surface of a wireless charging device; suspending the search for the chargeable device when a response to an analog ping transmitted through a first power transmitting coil indicates that an object is located in proximity to the wireless charging device; transmitting a first digital ping from the first transmitting circuit through the first power transmitting coil; transmitting power through the first power transmitting coil when a response to the first digital ping is received; resuming the search for the chargeable device using analog pings; and transmitting power through a second power transmitting coil when a response to a second digital ping indicates that more efficient power transfer is available through the second power transmitting coil.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for searching a charging surface of a wireless charging device, comprising:
initiating a search for a chargeable device using analog pings transmitted by a first transmitting circuit through power transmitting coils associated with the charging surface;
suspending the search for the chargeable device when a response to an analog ping transmitted through a first power transmitting coil indicates that an object is located in proximity to the wireless charging device;
transmitting a first digital ping from the first transmitting circuit through the first power transmitting coil;
transmitting power through the first power transmitting coil when a response to the first digital ping is received;
resuming the search for the chargeable device using analog pings; and
transmitting power through a second power transmitting coil when a response to a second digital ping indicates that more efficient power transfer is available through the second power transmitting coil.

2. The method of claim 1, wherein power transmission through the first power transmitting coil is terminated when power transmission through the second power transmitting coil commences.

3. The method of claim 1, wherein information encoded in the response to the second digital ping indicates that more efficient power transfer is available through the second power transmitting coil.

4. The method of claim 1, wherein a difference between information encoded in the response to the first digital ping and information encoded in the response to the second digital ping indicates that more efficient power transfer is available through the second power transmitting coil.

5. The method of claim 1, wherein resuming the search for the chargeable device comprises:
suspending power transmission through the first power transmitting coil when a second analog ping is transmitted through one or more other power transmitting coils.

6. The method of claim 1, wherein resuming the search for the chargeable device comprises transmitting one or more analog pings through a second transmitting circuit.

7. The method of claim 1, wherein resuming the search for the chargeable device comprises:
suspending power transmission through the first power transmitting coil when a third digital ping is transmitted through a third power transmitting coil.

8. The method of claim 1, wherein resuming the search for the chargeable device comprises transmitting one or more digital pings through a second transmitting circuit.

9. The method of claim 1, wherein each power transmitting coil comprises a plurality of coils.

10. The method of claim 1, further comprising:
generating an optimal charging configuration based on digital ping response strength.

11. The method of claim 1, further comprising:
generating an optimal charging configuration based on information encoded in the response to the first digital ping or based on information encoded in the response to the second digital ping.

12. The method of claim 1, further comprising:
comparing signal strength of responses to analog ping transmitted by each of a plurality of power transmitting coils; and
generating a charging configuration using a power transmitting coil in the plurality of power transmitting coils that has a strongest ping response strength.

13. The method of claim 1, wherein each power transmitting coil comprises a Litz coil.

14. The method of claim 1, wherein responses to analog pings that indicate that an object is located in proximity to the wireless charging device comprise changes in resonant frequency of a tank circuit in the first transmitting circuit.

15. The method of claim 1, wherein responses to analog pings that indicate that an object is located in proximity to the wireless charging device comprise changes in inductance of a tank circuit in the first transmitting circuit.

16. An apparatus comprising:
means for transferring power through a charging surface of a wireless charging device to one or more chargeable devices, including one or more transmitting circuits;
means for searching for a chargeable device, including means for transmitting analog pings and means for transmitting digital pings;
processing means configured to:
initiate a search for a chargeable device by causing a first transmitting circuit to transmit analog pings through power transmitting coils associated with the charging surface;
suspend the search for the chargeable device when a response to an analog ping transmitted through a first power transmitting coil indicates that an object is located in proximity to the wireless charging device;
causing the first transmitting circuit to transmit a first digital ping through the first power transmitting coil;
transmit power through the first power transmitting coil when a response to the first digital ping is received; and
resume the search for the chargeable device using analog pings; and
transmit power through a second power transmitting coil when a response to a second digital ping indicates that more efficient power transfer is available through the second power transmitting coil.

17. The apparatus of claim 16, wherein power transmission through the first power transmitting coil is terminated when power transmission through the second power transmitting coil commences.

18. The apparatus of claim 16, wherein the search for the chargeable device is resumed by suspending power transmission through the first power transmitting coil when a second analog ping is transmitted through one or more other power transmitting coils.

19. The apparatus of claim 16, wherein resuming the search for the chargeable device comprises transmitting one or more digital pings through a second transmitting circuit.

20. A processor-readable storage medium comprising code for:
initiating a search for a chargeable device using analog pings transmitted by a first transmitting circuit through power transmitting coils associated with a charging surface of a wireless charging device;
suspending the search for the chargeable device when a response to an analog ping transmitted through a first power transmitting coil indicates that an object is located in proximity to the wireless charging device;
transmitting a first digital ping from the first transmitting circuit through the first power transmitting coil;
transmitting power through the first power transmitting coil when a response to the first digital ping is received;
resuming the search for the chargeable device using analog pings; and
transmitting power through a second power transmitting coil when a response to a second digital ping indicates that more efficient power transfer is available through the second power transmitting coil.
